(19) United States
(12) Patent Application Publication
(10) Pub. No.: US 2023/0383802 A1
(43) Pub. Date: Nov. 30, 2023

(54) BRAKE DEVICE FOR RAILWAY VEHICLE

(71) Applicant: NABTESCO CORPORATION, Tokyo (JP)

(72) Inventors: Takashi UTSUMI, Tokyo (JP); Tomoya OHNO, Tokyo (JP)

(21) Appl. No.: 18/300,898

(22) Filed: Apr. 14, 2023

(30) Foreign Application Priority Data
May 24, 2022 (JP) 2022-084472

(51) Int. Cl. F16D 65/18

(52) U.S. Cl. CPC F16D 65/183; F16D 2121/24

(57) ABSTRACT

A brake device for a railway vehicle includes: an electric motor; a speed reducer having an output rotator that outputs a rotational force input from the electric motor; a conversion mechanism having an input rotator and a linear motion member, the input rotator being configured to receive the rotational force output from the output rotator, the linear motion member being configured to convert rotational motion of the input rotator into linear motion in the moving directions parallel to the rotational axis of the input rotator; and friction members configured to receive the linear motion of the linear motion member to be pressed against the brake-applied member of the railway vehicle, so as to brake the railway vehicle. The input rotator is movable relative to the output rotator in the moving directions and is capable of transmitting the rotational motion of the output rotator to the linear motion member.

### CROSS-REFERENCE TO RELATED APPLICATIONS

This application is based on and claims the benefit of priority from Japanese Patent Application Serial No. 2022-084472 (filed on May 24, 2022), the contents of which are hereby incorporated by reference in their entirety.

### TECHNICAL FIELD

The present invention relates to a brake device for a railway vehicle.

### BACKGROUND

Electric brake devices are conventionally known as brake devices for vehicles that brake a vehicle by driving of an electric motor. For example, the electric brake device disclosed in Japanese Patent No. 5795908 includes a rotating shaft driven by an electric motor, a linear motion mechanism that converts rotation of the rotating shaft into linear motion of a linear motion member, a caliper body that houses the linear motion member so as to be slidable in an axial direction, a friction pad located at the front end of the linear motion member in the axial direction, and a reaction force receiving member that receives a reaction force acting on the linear motion member backward in the axial direction when the linear motion member presses the friction pad. The linear motion mechanism includes a plurality of planetary rollers in contact with the outer diameter surface of the rotating shaft, and an outer ring member arranged to surround the plurality of planetary rollers and serving as the linear motion member. When the outer ring member presses the friction pad forward in the axial direction, the reaction force (brake reaction force) acting on the outer ring member backward in the axial direction is received by the reaction force receiving member.

However, the planetary rollers are engaged with the outer ring member and thus are hardly movable in the direction of the brake reaction force. Therefore, the planetary rollers are also subjected to the brake reaction force, which is likely to damage the planetary gear mechanism. The above problem is pronounced particularly in railway vehicles because of the large braking force.

### SUMMARY

The present invention is intended to overcome the above problem, and one object thereof is to provide a brake device for a railway vehicle having a lower possibility of damage to a speed reducer due to a brake reaction force.

To overcome the above problem, aspects of the present invention are configured as follows. (1) A brake device for a railway vehicle according to an aspect of the disclosure comprises: an electric motor; a speed reducer including an output rotator configured to output a rotational force input from the electric motor; a conversion mechanism including an input rotator and a linear motion member, the input rotator being configured to receive the rotational force output from the output rotator, the linear motion member being configured to convert rotational motion of the input rotator into linear motion in moving directions parallel to a rotation axis of the input rotator; and a friction member configured to receive the linear motion of the linear motion member to be pressed against a brake-applied member of a railway vehicle, so as to brake the railway vehicle, wherein the input rotator is movable relative to the output rotator in the moving directions and is capable of transmitting rotational motion of the output rotator to the linear motion member.

With this configuration, since the input rotator can move relative to the output rotator in the moving directions, the reaction force (brake reaction force) generated when the friction members are pressed against the brake-applied member does not act on the speed reducer. This can lower the possibility of damage to the speed reducer due to the brake reaction force.
(2) The brake device for a railway vehicle according to (1) above may further comprise: a housing that houses the conversion mechanism such that the linear motion member is movable in the moving directions; and a reaction force receiving member provided between the housing and an end of the input rotator in one of the moving directions opposite to a direction for pressing the friction member against the brake-applied member, the reaction force receiving member being configured to receive a reaction force acting on the input rotator when the friction member is pressed against the brake-applied member.
(3) In the brake device for a railway vehicle according to (1) or (2) above, it is also possible that the input rotator is a male screw, the linear motion member is a female screw meshing with the male screw, the output rotator and the male screw have splines that engage with each other, such that the output rotator and the male screw are movable relative to each other in the moving directions, and the rotational motion of the output rotator input via the splines is transmitted to the male screw and converted into the linear motion of the female screw.
(4) In the brake device for a railway vehicle according to any one of (1) to (3) above, it is also possible that the output rotator has a hollow structure, and a reaction force receiving member configured to receive a reaction force acting on the input rotator when the friction member is pressed against the brake-applied member is provided on an end of a male screw extending through an interior of the hollow structure.
(5) In the brake device for a railway vehicle according to (3) or (4) above, it is also possible that the conversion mechanism is a ball screw mechanism.
(6) The brake device for a railway vehicle according to any one of (1) to (5) above may further comprise: a security power unit provided separately from a regular electric motor as the electric motor; and a gear mechanism configured to receive output of the regular electric motor and output of the security power unit, wherein the gear mechanism includes: a first gear configured to receive the output of the regular electric motor; a second gear configured to receive the output of the security power unit; and a third gear configured to output to the speed reducer a rotational power input from the first gear or the second gear.
(7) In the brake device for a railway vehicle according to (6) above, it is also possible that the gear mechanism is a planetary gear mechanism having a sun gear, planetary gears, and an internal gear, the first gear is one of the sun gear and the planetary gears, the second gear is the other of the sun gear and the planetary gears, and the third gear is the internal gear.
(8) In the brake device for a railway vehicle according to (7) above, it is also possible that the security power unit includes a spring and a retention mechanism configured to retain the spring in a biased state, the first gear is the sun gear, the second gear is the planetary gears, and a reduction ratio between the sun gear and the internal gear is greater than a reduction ratio between the planetary gears and the internal gear.
(9) In the brake device for a railway vehicle according to (8) above, it is also possible that a first rotation lock mechanism capable of locking rotation of the first gear is provided between the regular electric motor and the first gear, the retention mechanism is a second rotation lock mechanism capable of locking rotation of the second gear, the brake device further comprises a control unit configured to control the first rotation lock mechanism, the second rotation lock mechanism, and the regular electric motor, and the control unit puts the spring into the biased state by driving the regular electric motor while controlling the first rotation lock mechanism and the second rotation lock mechanism so as not to lock rotation of the first gear and the second gear.
(10) In the brake device for a railway vehicle according to any one of (6) to (9), it is also possible that a first rotation lock mechanism capable of locking rotation of the first gear is provided between the regular electric motor and the first gear, a second rotation lock mechanism capable of locking rotation of the second gear is provided between the security power unit and the second gear, when the regular electric motor is driven, the first rotation lock mechanism does not lock rotation of the first gear, and the second rotation lock mechanism locks rotation of the second gear, and when the security power unit is driven, the first rotation lock mechanism locks rotation of the first gear, and the second rotation lock mechanism does not lock rotation of the second gear.
(11) In the brake device for a railway vehicle according to (7) above, it is also possible that the security power unit is a direct current (DC) electric motor, the regular electric motor is an alternating current (AC) electric motor, the first gear is the planetary gears, the second gear is the sun gear, and a reduction ratio between the sun gear and the internal gear is greater than a reduction ratio between the planetary gears and the internal gear.
(12) In the brake device for a railway vehicle according to any one of (1) to (11) above, it is also possible that the speed reducer includes: a case rotatably retaining an input gear, the input gear being configured to receive output of the electric motor; a crankshaft rotatably supported by the case and having an eccentric region that revolves as the crankshaft receives rotation of the input gear; an oscillating gear having external teeth, a number of the external teeth being smaller than a number of internal tooth pins, the external teeth being meshed with the internal tooth pins, the oscillating gear being configured to receive a revolving force from the eccentric region of the crankshaft to rotate oscillatorily; the output rotator having an annular shape and rotatably supported by the case, the output rotator having a plurality of pin grooves, the plurality of pin grooves being formed in an inner periphery of the output rotator and spaced equally in a circumferential direction; and a plurality of internal tooth pins rotatably retained in the plurality of pin grooves of the output rotator.

### Advantageous Effects

The present invention provides a brake device for a railway vehicle having a lower possibility of damage to a speed reducer due to a brake reaction force.

### BRIEF DESCRIPTION OF THE DRAWINGS

FIG. 1 is a block diagram showing a brake device for a railway vehicle according to a first embodiment.

FIG. 2 is a cross-sectional perspective view schematically showing the brake device for a railway vehicle according to the first embodiment.

FIG. 3 is a cross-sectional perspective view showing the perimeter around a speed reducer according to the first embodiment.

FIG. 4 is a perspective view showing the connection between a gear mechanism and the speed reducer according to the first embodiment.

FIG. 5 is a cross-sectional perspective view of the speed reducer according to the first embodiment.

FIG. 6 illustrates an operation of normal braking according to the first embodiment.

FIG. 7 illustrates an operation of security braking according to the first embodiment.

FIG. 8 illustrates an operation of loosening the parking braking according to the first embodiment.

FIG. 9 illustrates an operation of manually releasing the parking braking according to the first embodiment.

FIG. 10 illustrates an operation of strong braking according to the first embodiment.

FIG. 11 is a block diagram showing a brake device for a railway vehicle according to a second embodiment.

FIG. 12 illustrates an operation of normal braking according to the second embodiment.

FIG. 13 illustrates an operation of security braking according to the second embodiment.

FIG. 14 illustrates an operation of energy charging according to the second embodiment.

FIG. 15 illustrates a return operation according to the second embodiment.

FIG. 16 illustrates an operation of manually releasing the parking braking according to the second embodiment.

FIG. 17 is a perspective view showing the connection between a gear mechanism and a speed reducer according to a third embodiment.

FIG. 18 is a perspective view showing the connection between a gear mechanism and a speed reducer according to a fourth embodiment.

FIG. 19 is a schematic diagram showing a point-of-effort driven configuration according to a fifth embodiment.

FIG. 20 is a schematic diagram showing a fulcrum driven configuration according to a sixth embodiment.

FIG. 21 is a cross-sectional view schematically showing a brake device for a railway vehicle according to a seventh embodiment.

FIG. 22 is a schematic diagram showing an example of application of a disc braking system according to the seventh embodiment.

FIG. 23 is a schematic diagram showing an example of application of a wheel tread braking system according to an eighth embodiment.

### DESCRIPTION OF THE PREFERRED EMBODIMENTS

Embodiments of the present invention will now be described with reference to the attached drawings. The following description of the embodiments will be based on a brake device for a railway vehicle as an example of an electric brake device. In the following description, terms such as “parallel,” “orthogonal,” “around” and “coaxial” describe relative or absolute positions. These terms are not only strictly used but also allow some tolerances and relative differences in angle and distance as long as the same effects can be still produced. In the drawings used for the following description, members are shown to different scales into recognizable sizes.

### First Embodiment

### <Brake Device for Railway Vehicle>

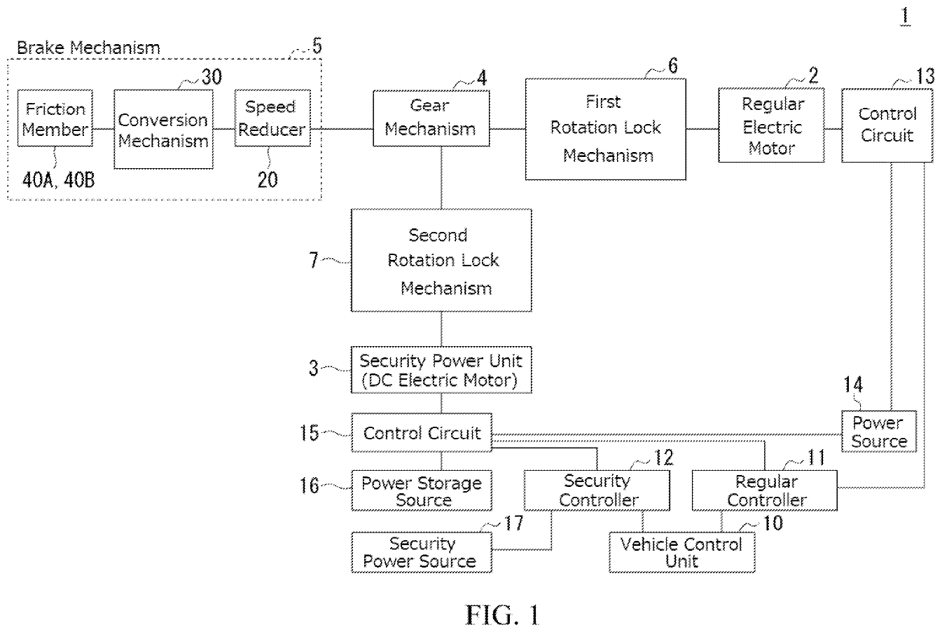

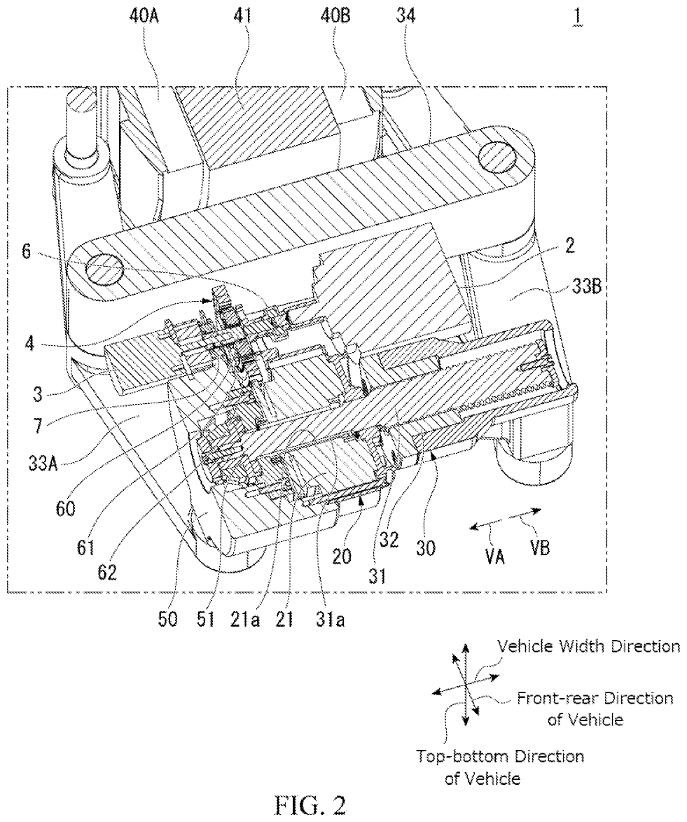

FIG. 1 is a block diagram showing a brake device 1 for a railway vehicle according to a first embodiment. FIG. 2 is a cross-sectional perspective view schematically showing the brake device 1 for a railway vehicle according to the first embodiment. In FIG. 2, the top-bottom direction of the vehicle refers to the top-bottom direction (height direction) of the railway vehicle, the front-rear direction of the vehicle refers to the front-rear direction of the railway vehicle, and the vehicle width direction refers to the width direction of the railway vehicle.

As shown in FIG. 1, the brake device 1 for a railway vehicle includes a regular electric motor 2 (an example of an electric motor), a security power unit 3, a gear mechanism 4, a brake mechanism 5, a first rotation lock mechanism 6, a second rotation lock mechanism 7, a vehicle control unit 10 (an example of a control unit), a regular controller 11, and a security controller 12.

In the present embodiment, the regular electric motor 2 is an AC electric motor. The security power unit 3 is a DC electric motor. The security power unit 3, which is an electric motor, is hereinafter also referred to as “security electric motor 3.” The gear mechanism 4 is a planetary gear mechanism (see FIG. 2) having a sun gear 60, planetary gears 61, and an internal gear 62. The brake mechanism 5 includes a speed reducer 20, a conversion mechanism 30, and friction members 40A and 40B.

The vehicle control unit 10 provides overall control of the components of the railway vehicle. For example, the vehicle control unit 10 controls the regular controller 11 and the security controller 12. A control circuit 13 such as an inverter is connected to the regular electric motor 2. For example, the regular controller 11 controls the rotational drive of the regular electric motor 2 via the control circuit 13. A control circuit 15 such as an inverter is connected to the security electric motor 3. For example, the regular controller 11 controls the rotational drive of the security electric motor 3 via the control circuit 15. The control circuits 13 and 15 are connected to a power source 14.

For example, the security controller 12 controls the rotational drive of the security electric motor 3 via the control circuit 15. The control circuit 15 is connected to a power storage source 16. The power storage source 16 is a drive energy source for the security braking and the parking braking in the event of power loss. For example, the power storage source 16 is a lithium ion storage battery or a capacitor. A security power source 17 is connected to the security controller 12.

As shown in FIG. 2, the regular electric motor 2 is disposed along the vehicle width direction. The regular electric motor 2 has an output shaft projecting toward one side in the vehicle width direction. The output shaft of the regular electric motor 2 is connected to the planetary gear mechanism 4 via the first rotation lock mechanism 6.

The security electric motor 3 is smaller than the regular electric motor 2. The security electric motor 3 is disposed along the vehicle width direction. The security electric motor 3 has an output shaft projecting toward the other side in the vehicle width direction. The output shaft of the security electric motor 3 is connected to the planetary gear mechanism 4 via the second rotation lock mechanism 7. The output shaft of the security electric motor 3 and the output shaft of the regular electric motor 2 are coaxial with each other.

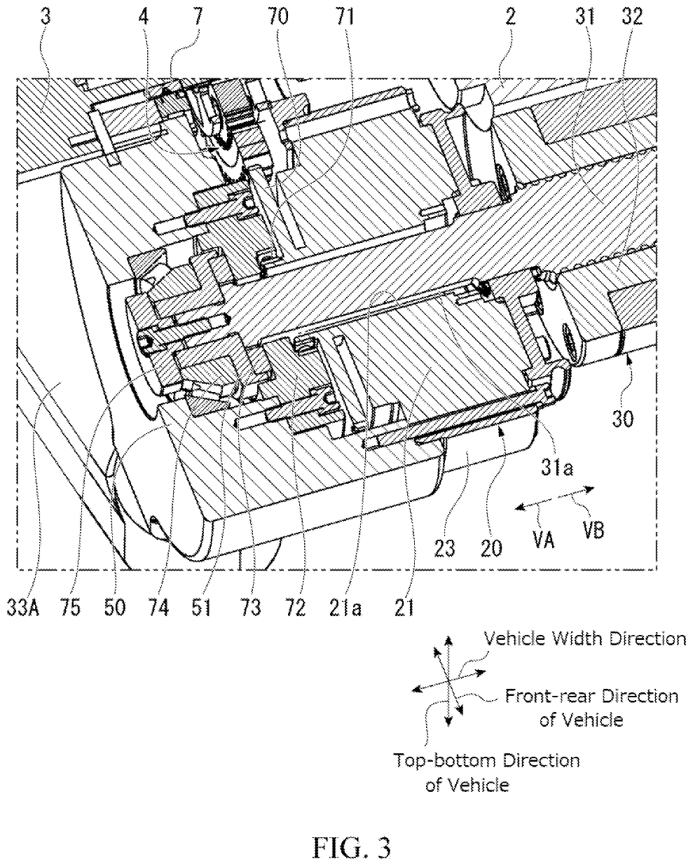

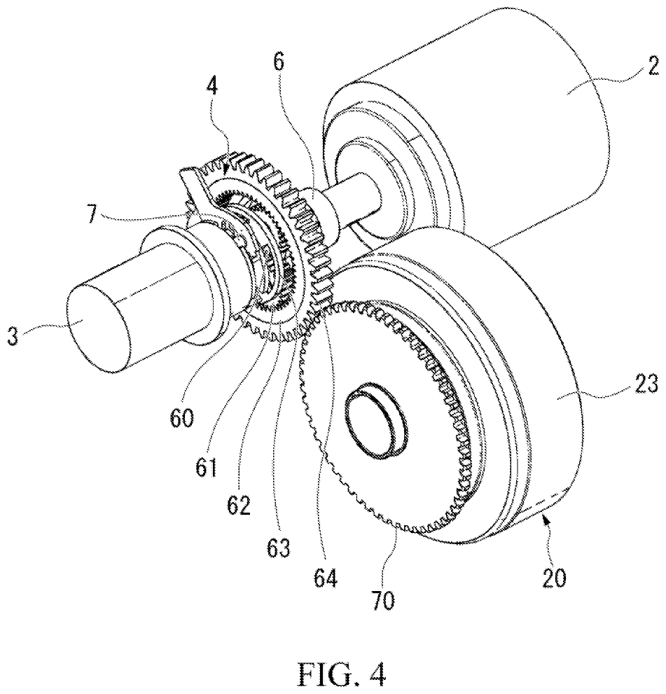

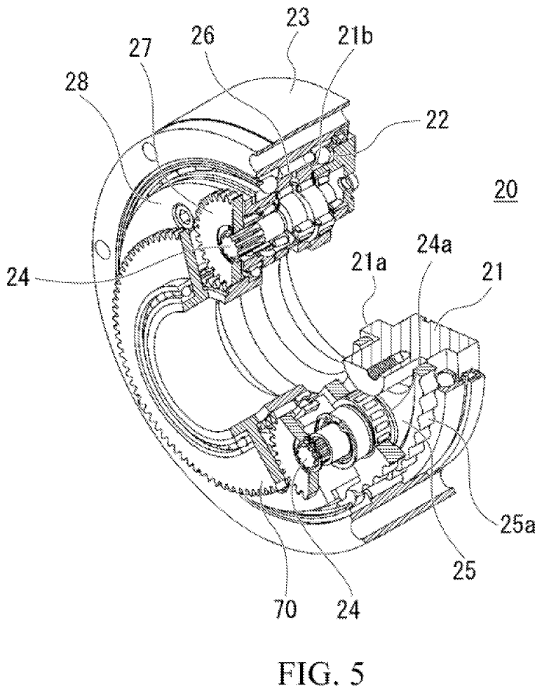

FIG. 3 is a cross-sectional perspective view showing the perimeter around the speed reducer 20 according to the first embodiment. FIG. 4 is a perspective view showing the connection between the gear mechanism 4 and the speed reducer 20 according to the first embodiment. FIG. 5 is a cross-sectional perspective view of the speed reducer 20 according to the first embodiment. As shown in FIG. 3, the speed reducer 20 includes an output rotator 21 that outputs the rotational force input from the regular electric motor 2. The output rotator 21 has a hollow structure. The output rotator 21 has a tubular shape extending along the vehicle width direction. As shown in FIG. 4, the speed reducer 20 is connected to the planetary gear mechanism 4 via an input gear 70.

The planetary gear mechanism 4 includes the planetary gears 61 (an example of first gear) to which the output of the regular electric motor 2 is input, the sun gear 60 (an example of a second gear) to which the output of the security electric motor 3 is input, and the internal gear 62 (an example of a third gear) for outputting to the speed reducer 20 the rotational power input from the sun gear 60 or the planetary gears 61. The sun gear 60 and the planetary gears 61 are connected by a planetary carrier 63. An external gear 64 is provided on the outer periphery of the internal gear 62.

In this embodiment, the first rotation lock mechanism 6 is provided between the regular electric motor 2 and the planetary gears 61. The first rotation lock mechanism 6 can lock the rotation of the planetary gears 61. For example, the first rotation lock mechanism 6 is formed of a non-excited electromagnetic clutch (brake), torque diode, etc.

The second rotation lock mechanism 7 is provided between the security electric motor 3 and the sun gear 60. The second rotation lock mechanism 7 can lock the rotation of the sun gear 60. For example, the second rotation lock mechanism 7 is formed of a non-excited electromagnetic clutch (brake).

In this embodiment, the output shaft of the regular electric motor 2 (AC electric motor) is connected to the planetary carrier 63 (planetary gears 61) via the first rotation lock mechanism 6. The output shaft of the security electric motor 3 (DC electric motor) is connected to the sun gear 60 via the second rotation lock mechanism 7. The speed reducer 20 is connected to the external gear 64 via the input gear 70.

The reduction ratio between the sun gear 60 and the internal gear 62 is greater than the reduction ratio between the planetary gears 61 and the internal gear 62. The reduction ratio between the sun gear 60 and the internal gear 62 is the ratio of the number of teeth on the sun gear 60 to the number of teeth on the internal gear 62. The reduction ratio between the planetary gears 61 and the internal gear 62 is the ratio of the number of teeth on the planetary gears 61 to the number of teeth on the internal gear 62.

As shown in FIG. 5, the speed reducer 20 is a precision speed reducer with a hollow structure. The speed reducer 20 includes a tubular case 23 which rotatably retains the input gear 70, a main bearing 22 provided on the inner periphery of the case 23, a crankshaft 24 rotatably supported by the case 23 and having an eccentric region 24a which revolves as the crankshaft 24 receives the rotation of the input gear an oscillating gear 25 which receives a revolving force from the eccentric region 24a of the crankshaft 24 to rotate oscillatorily, an annular output rotator 21 rotatably supported by the case 23 and having a plurality of pin grooves 21b, which pin grooves 21b are formed in the inner periphery of the output rotator 21 and spaced equally in the circumferential direction, and a plurality of internal tooth pins 26 rotatably retained in the pin grooves 21b of the output rotator 21.

The oscillating gear 25 has external teeth 25a, and the number of the external teeth 25a is smaller than the number of the internal tooth pins 26. The oscillating gear 25 receives the revolving force from the eccentric region 24a of the crankshaft 24 to rotate oscillatorily, while meshing the external teeth 25a with the internal tooth pins 26. In the drawing, the sign 27 denotes a spur gear provided on the crankshaft 24, and the sign 28 denotes a holding flange provided between the spur gear 27 and the case 23.

As shown in FIG. 2, the conversion mechanism 30 includes an input rotator 31 to which the rotational force output from the output rotator 21 is input, and a linear motion member 32 that converts the rotational motion of the input rotator 31 into linear motion in the moving directions VA and VB parallel to the rotation axis of the input rotator 31. In this embodiment, the conversion mechanism 30 is a ball screw mechanism. The input rotator 31 is a male screw 31. The linear motion member 32 is a female screw 32 that meshes with the male screw 31.

As shown in FIG. 3, the output rotator 21 and the male screw 31 have splines 21a and 31a that engage with each other, such that the output rotator 21 and the male screw 31 are movable relative to each other in the moving directions VA and VB. The output rotator 21 has splines 21a (female splines 21a) provided at equal intervals in the circumferential direction in the inner periphery of the output rotator 21. The male screw 31 has splines 31a (male splines 31a) provided at equal intervals in the circumferential direction on the outer periphery of the male screw 31. Thus, the rotational motion of the output rotator 21 input via the splines 21a and 31a is transmitted to the male screw 31 and converted into linear motion of the female screw 32.

As shown in FIG. 2, a pair of friction members 40A and 40B are arranged in the vehicle width direction so as to sandwich a brake-applied member 41 of the railway vehicle. The linear motion of the female screw 32 in the moving directions VA and VB is transmitted to the friction members 40A and 40B. As a result, the friction members 40A and 40B are pressed against the brake-applied member 41 to brake the railway vehicle.

The brake-applied member 41 is a disc attached to the axle of the railway vehicle. The pair of friction members 40A and 40B constitute a disc brake unit (DBU) that sandwiches the disc on both sides. Of the pair of friction members 40A and 40B, the friction member 40A on one side in the vehicle width direction is hereinafter also referred to as “the first friction member 40A,” and the friction member 40B on the other side in the vehicle width direction as “the second friction member 40B.”

The brake device 1 for a railway vehicle includes a housing 50 that houses the conversion mechanism 30 so that the female screw 32 can move in the moving directions VA and VB. The housing 50 houses the portions of the speed reducer 20 and the conversion mechanism 30 on one side in the vehicle width direction.

The conversion mechanism 30 includes a pair of arms 33A and 33B spaced apart in the vehicle width direction and a coupling member 34 that couples the pair of arms 33A and 33B. Of the pair of arms 33A and 33B, the arm 33A on one side in the vehicle width direction is hereinafter also referred to as “the first arm 33A,” and the arm 33B on the other side in the vehicle width direction as “the second arm 33B.”

The first arm 33A extends along the front-rear direction of the vehicle so as to connect between the housing 50 and the first friction member 40A. The first arm 33A has a length along the front-rear direction of the vehicle. One end of the first arm 33A in its longitudinal direction is coupled to the housing 50 so as to be rotatable relative to the housing 50 about an axis along the top-bottom direction of the vehicle. The other end of the first arm 33A in its longitudinal direction is coupled to the first friction member 40A so as to be rotatable relative to the first friction member 40A about an axis along the top-bottom direction of the vehicle.

The second arm 33B extends along the front-rear direction of the vehicle so as to connect between the end of the female screw 32 opposite to the speed reducer (the end on the opposite side in the vehicle width direction) and the second friction member 40B. The second arm 33B has a length along the front-rear direction of the vehicle. One end of the second arm 33B in its longitudinal direction is coupled to the end of the female screw 32 opposite to the speed reducer 20 so as to be rotatable relative this end of the female screw 32 about an axis along the top-bottom direction of the vehicle. The other end of the second arm 33B in its longitudinal direction is coupled to the second friction member 40B so as to be rotatable relative to the second friction member 40B about an axis along the top-bottom direction of the vehicle.

The coupling member 34 extends along the vehicle width direction so as to connect between the pair of arms 33A and 33B. The coupling member 34 has a length along the vehicle width direction. One end of the coupling member 34 in its longitudinal direction is coupled to the middle portion of the first arm 33A in its longitudinal direction so as to be rotatable relative to this middle portion of the first arm 33A about an axis along the top-bottom direction of the vehicle. The other end of the coupling member 34 in its longitudinal direction is coupled to the middle portion of the second arm 33B in its longitudinal direction so as to be rotatable relative to this middle portion of the second arm 33B about an axis along the top-bottom direction of the vehicle.

The brake device 1 for a railway vehicle includes a reaction force receiving member 51 that receives the reaction force acting on the male screw 31 when the friction members 40A and 40B are pressed against the brake-applied member 41. The reaction force receiving member 51 is provided between the housing 50 and the end of the male screw 31 in one of the moving directions VA and VB (indicated by the arrow VA in the drawing) opposite to the direction for pressing the friction members and 40B against the brake-applied member 41. The male screw 31 is movable relative to the output rotator 21 in the moving directions VA and VB. The male screw 31 is capable of transmitting the rotational motion of the output rotator 21 to the female screw 32. The reaction force receiving member 51 is provided on the end of the male screw 31 that extends through the interior of the output rotator 21 having a hollow structure.

As shown in FIG. 3, the housing 50 covers the input gear 70 from one side in the vehicle width direction. The case 23 of the speed reducer 20 is fixed to the housing 50 with bolts or other fastening members. The housing 50 receives the thrust from the male screw 31 and transmits the braking force. The housing 50 encloses a retaining bearing 71 that rotatably retains the input gear 70, a bearing support member 72 that supports the retaining bearing 71, a spacer 73 provided between the bearing support member 72 and the reaction force receiving member 51, a tapered roller bearing 74 provided between the reaction force receiving member 51 and the housing 50, and a lid member 75 that covers the reaction force receiving member 51 from one side in the vehicle width direction.

The bearing support member 72 is fixed to the housing 50 with bolts or other fastening members. For example, the spacer 73 is a slide bearing or a thrust bearing. The reaction force receiving member 51 receives the thrust from the male screw 31 and transmits the force to the inner ring of the tapered roller bearing 74. The outer ring of the tapered roller bearing 74 is fixed to the housing 50 to allow the tapered roller bearing 74 to rotate with low friction while receiving a thrust load.

For example, the reaction force receiving member 51 is a bearing member. The reaction force receiving member 51 can rotate together with the male screw 31, the inner ring of the tapered roller bearing 74, and the lid member 75. The lid member 75 serves to retain the male screw 31. The lid member 75 is fixed to the end of the male screw 31 (the end in the direction of the arrow VA in the drawing) with a bolt or other fastening member. The lid member 75 can rotate together with the male screw 31, the reaction force receiving member 51, and the inner ring of the tapered roller bearing 74.

For example, when the output of the regular electric motor 2 is input to the input gear 70, a decelerated rotational force is output from the output rotator 21 of the speed reducer 20. The rotational force output from the output rotator 21 is then input to the male screw 31. As described above, the output rotator 21 and the male screw 31 have splines 21a and 31a that engage with each other, such that the output rotator 21 and the male screw 31 are movable relative to each other in the moving directions VA and VB. The rotational motion of the output rotator 21 input via the splines 21a and 31a is transmitted to the male screw 31. The rotational motion of the male screw 31 is converted into a linear motion of the female screw 32 in the moving directions VA and VB.

As shown in FIG. 2, the linear motion of the female screw 32 in the moving directions VA and VB is transmitted to the friction members 40A and 40B via the arms 33A and 33B and the coupling member 34. The arms 33A and 33B move in such a direction that the ends thereof coupled to the friction members 40A and 40B come closer to each other using the coupling member 34 as a fulcrum. As a result, the friction members 40A and 40B are pressed against the brake-applied member 41. Thus, the railway vehicle is braked.

<Example of Braking Operation>

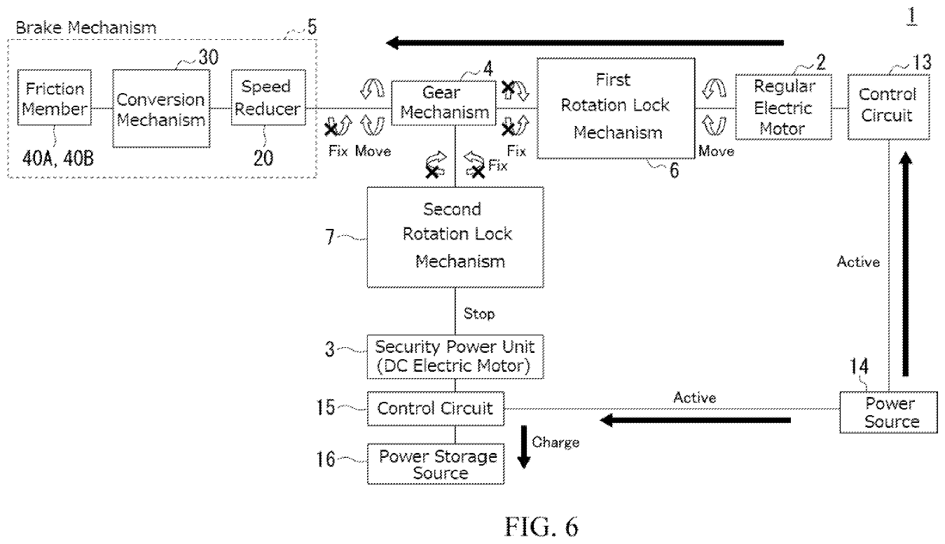

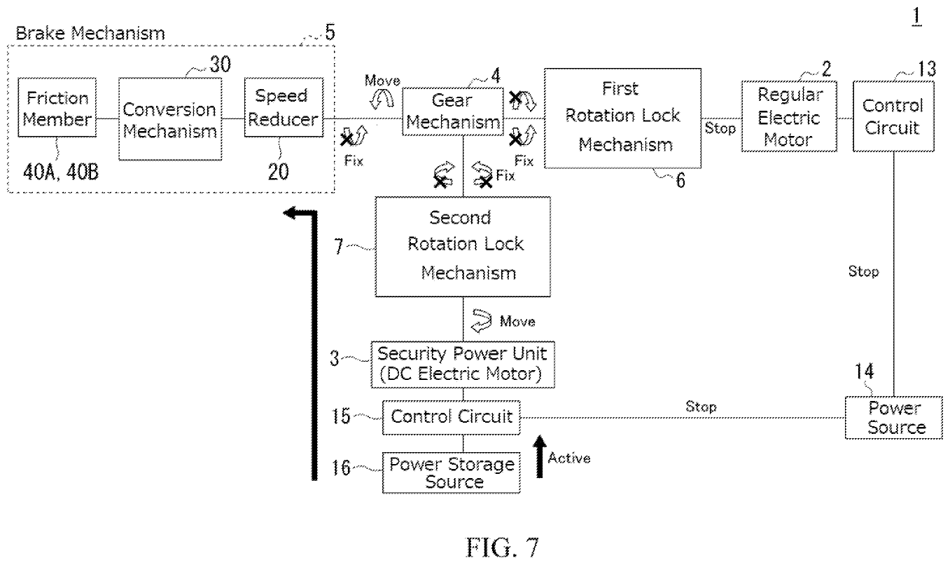

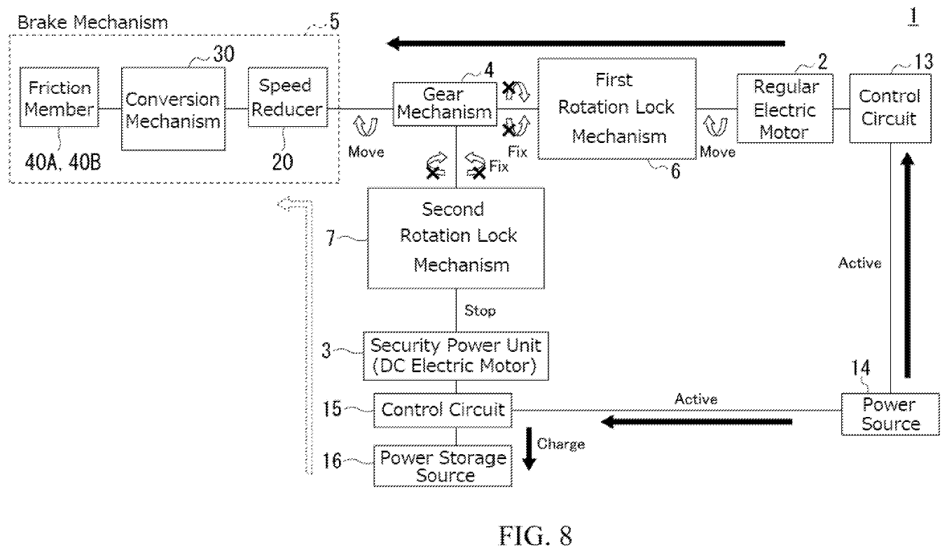

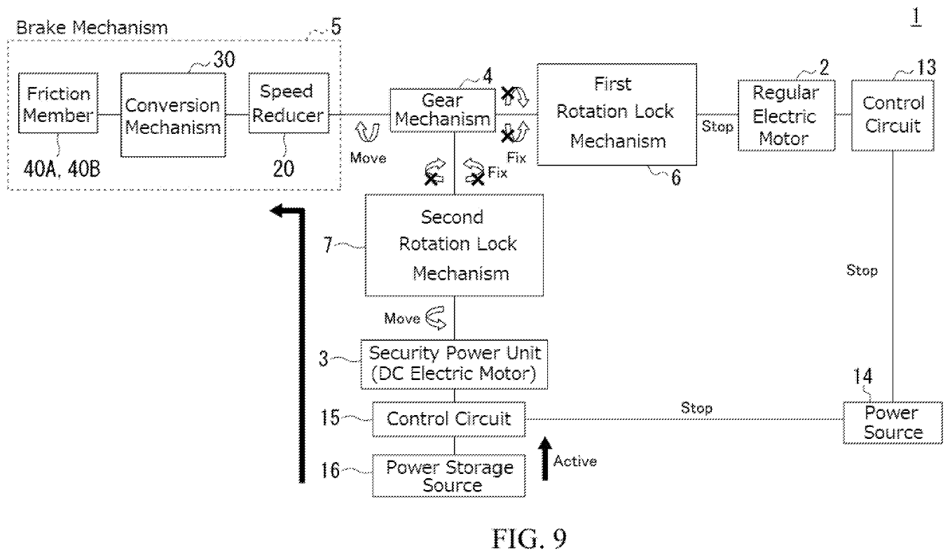

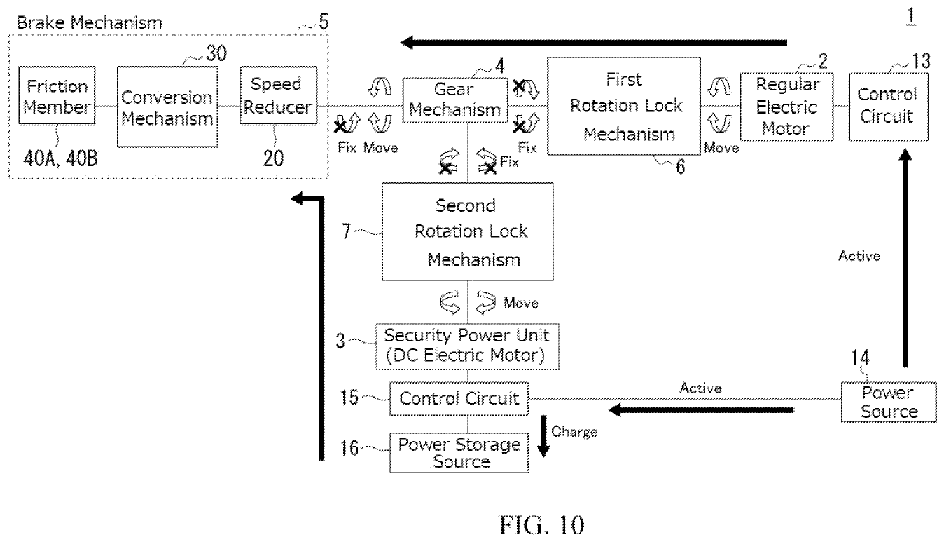

Next, an example of braking operation of the brake device for a railway vehicle according to the embodiment is described with reference to FIGS. 6 to 10. FIG. 6 illustrates an operation of normal braking according to the first embodiment. FIG. 7 illustrates an operation of security braking according to the first embodiment. FIG. 8 illustrates an operation of loosening the parking braking according to the first embodiment. FIG. 9 illustrates an operation of manually releasing the parking braking according to the first embodiment. FIG. 10 illustrates an operation of strong braking according to the first embodiment. FIGS. 6 to 10 do not show the components such as the vehicle control unit 10 shown in FIG. 1.

<Normal Braking>

As shown in FIG. 6, in the normal braking operation, the regular electric motor 2 is driven. In the normal braking operation, the power source 14 supplies power to the control circuit 13 for the regular electric motor 2. In the normal braking operation, the security electric motor 3 is not driven. In the normal braking operation, the power source 14 supplies power to the power storage source 16 for the security electric motor 3. Thus, the power storage source 16 is charged.

When the regular electric motor 2 is driven, the first rotation lock mechanism 6 does not lock the rotation of the planetary gears 61, while the second rotation lock mechanism 7 locks the rotation of the sun gear 60. The regular electric motor 2 is capable of forward and reverse rotation with the supplied electric power. The forward rotation of the regular electric motor 2 is the rotation in one direction around the output shaft of the regular electric motor 2. The reverse rotation of the regular electric motor 2 is in the opposite direction to the forward rotation of the regular electric motor 2.

The forward and reverse rotation of the regular electric motor 2 is transmitted to the brake mechanism 5 through the first rotation lock mechanism 6 and the planetary gear mechanism 4. For example, in the normal braking operation, forward rotation of the regular electric motor 2 tightens the braking, and reverse rotation thereof loosens the braking. The tightening of the braking refers to application of a braking force, and the loosening of the braking refers to release of the braking force.

The first rotation lock mechanism 6 constantly permits (does not lock) the rotation in both directions transmitted from the regular electric motor 2 toward the planetary gears 61, but constantly locks the rotation in both directions transmitted from the planetary gears 61 toward the regular electric motor 2. The second rotation lock mechanism 7 constantly locks the rotation in both directions transmitted from the sun gear 60 toward the security electric motor 3. In the normal braking operation, power is transmitted in the planetary gear mechanism 4 from the planetary gears 61 on the regular electric motor 2 side to the internal gear 62 on the speed reducer 20 side, with the sun gear 60 on the security electric motor 3 side fixed.

In the normal braking operation, to retain the braking (such as for parking braking), the regular electric motor 2 is stopped with a predetermined amount of braking force applied.

<Security Braking>

As shown in FIG. 7, in the security braking operation, the security electric motor 3 is driven. In the security braking operation, the power storage source 16 supplies power to the control circuit 15 for the security electric motor 3. In the security braking operation, the regular electric motor 2 is not driven. In the security braking operation, the power source 14 does not supply power to the control circuit 13 for the regular electric motor 2.

When the security electric motor 3 is driven, the first rotation lock mechanism 6 locks the rotation of the planetary gears 61, while the second rotation lock mechanism 7 does not lock the rotation of the sun gear 60. The security electric motor 3 is capable of forward or reverse rotation with the supplied electric power. The forward rotation of the security electric motor 3 is the rotation in one direction around the output shaft of the security electric motor 3. The reverse rotation of the security electric motor 3 is in the opposite direction to the forward rotation of the security electric motor 3.

The forward or reverse rotation of the security electric motor 3 is transmitted to the brake mechanism 5 through the second rotation lock mechanism 7 and the planetary gear mechanism 4. For example, in the security braking operation, forward or reverse rotation of the security electric motor 3 tightens the braking (applies the braking force).

The first rotation lock mechanism 6 constantly locks the rotation in both directions transmitted from the planetary gears 61 toward the regular electric motor 2. The second rotation lock mechanism 7 constantly permits (does not lock) the forward or reverse rotation (driven by the power storage source 16) transmitted from the security electric motor 3 toward the sun gear 60, but constantly locks the rotation in both directions transmitted from the sun gear 60 toward the security electric motor 3. In the security braking operation, power is transmitted in the planetary gear mechanism 4 from the sun gear 60 on the security electric motor 3 side to the internal gear 62 on the speed reducer 20 side, with the planetary gears 61 on the regular electric motor 2 side fixed. In the security braking operation, to retain the braking (such as for parking braking), the security electric motor 3 is stopped with a predetermined amount of braking force applied.

<Parking Braking>

As shown in FIG. 8, in the operation of loosening the parking braking, the regular electric motor 2 is driven. In the operation of loosening the parking braking, the power source 14 supplies power to the control circuit 13 for the regular electric motor 2. In the operation of loosening the parking braking, the security electric motor 3 is not driven. In the operation of loosening the parking braking, the power source 14 supplies power to the power storage source 16 for the security electric motor 3. Thus, the power storage source 16 is charged.

When the regular electric motor 2 is driven, the first rotation lock mechanism 6 does not lock the rotation of the planetary gears 61, while the second rotation lock mechanism 7 locks the rotation of the sun gear 60. The regular electric motor 2 is capable of forward or reverse rotation with the supplied electric power.

The forward or reverse rotation of the regular electric motor 2 is transmitted to the brake mechanism 5 through the first rotation lock mechanism 6 and the planetary gear mechanism 4. For example, in the operation of loosening the parking braking, forward or reverse rotation of the regular electric motor 2 loosens the braking (releases the braking force).

The first rotation lock mechanism 6 constantly permits (does not lock) the forward or reverse rotation transmitted from the regular electric motor 2 toward the planetary gears 61, but constantly locks the rotation in both directions transmitted from the planetary gears 61 toward the regular electric motor 2. The second rotation lock mechanism 7 constantly locks the rotation in both directions transmitted from the sun gear 60 toward the security electric motor 3. In the operation of loosening the parking braking, power is transmitted in the planetary gear mechanism 4 from the planetary gears 61 on the regular electric motor 2 side to the internal gear 62 on the speed reducer 20 side, with the sun gear 60 on the security electric motor 3 side fixed. In the operation of loosening the parking braking, the parking braking is not necessarily loosened by only the driving force of the regular electric motor 2. It is also possible to loosen the parking braking by only the driving force of the security electric motor 3 (indicated by the dotted line in the drawing) or by both driving forces.

<Manual Releasing of Parking Braking>

As shown in FIG. 9, in the operation of manually releasing the parking braking, the security electric motor 3 is driven. In the operation of manually releasing the parking braking, the power storage source 16 supplies power to the control circuit 15 for the security electric motor 3. In the operation of manually releasing the parking braking, the regular electric motor 2 is not driven. In the operation of manually releasing the parking braking, the power source 14 does not supply power to the control circuit 13 for the regular electric motor 2.

When the security electric motor 3 is driven, the first rotation lock mechanism 6 locks the rotation of the planetary gears 61, while the second rotation lock mechanism 7 does not lock the rotation of the sun gear 60. The security electric motor 3 is capable of forward or reverse rotation with the supplied electric power.

The forward or reverse rotation of the security electric motor 3 is transmitted to the brake mechanism 5 through the second rotation lock mechanism 7 and the planetary gear mechanism 4. For example, in the security braking operation, forward or reverse rotation of the security electric motor 3 loosens the braking (releases the braking force).

The first rotation lock mechanism 6 constantly locks the rotation in both directions transmitted from the planetary gears 61 toward the regular electric motor 2. The second rotation lock mechanism 7 constantly permits (does not lock) the forward or reverse rotation (driven by the power storage source 16) transmitted from the security electric motor 3 toward the sun gear 60, but constantly locks the rotation in both directions transmitted from the sun gear 60 toward the security electric motor 3. In the operation of manually releasing the parking braking, power is transmitted in the planetary gear mechanism 4 from the sun gear 60 on the security electric motor 3 side to the internal gear 62 on the speed reducer 20 side, with the planetary gears 61 on the regular electric motor 2 side fixed. In the operation of manually releasing the parking braking, after the braking is loosened, the security electric motor 3 is stopped. In the operation of manually releasing the parking braking, it is also possible to press a caliper body of the brake mechanism 5 or a push switch of a controller to loosen the parking braking.

<Strong Braking>

As shown in FIG. 10, in the strong braking operation, both the regular electric motor 2 and the security electric motor 3 are driven. In the strong braking operation, the power source 14 supplies power to the control circuit 13 for the regular electric motor 2. In the strong braking operation, the power source 14 supplies power to the power storage source 16 for the security electric motor 3. Thus, the power storage source 16 is charged.

When the regular electric motor 2 is driven, the first rotation lock mechanism 6 does not lock the rotation of the planetary gears 61. The regular electric motor 2 is capable of forward and reverse rotation with the supplied electric power. When the security electric motor 3 is driven, the second rotation lock mechanism 7 does not lock the rotation of the sun gear 60. The security electric motor 3 is capable of forward and reverse rotation with the supplied electric power.

The forward and reverse rotation of the regular electric motor 2 is transmitted to the brake mechanism 5 through the first rotation lock mechanism 6 and the planetary gear mechanism 4. In addition, the forward and reverse rotation of the security electric motor 3 is transmitted to the brake mechanism 5 through the second rotation lock mechanism 7 and the planetary gear mechanism 4. For example, in the strong braking operation, both forward rotation of the regular electric motor 2 and forward rotation of the security electric motor 3 tighten the braking (apply the braking force). Thus, in the strong braking operation, a stronger braking force can be applied than in the normal braking operation.

The first rotation lock mechanism 6 constantly permits (does not lock) the rotation in both directions transmitted from the regular electric motor 2 toward the planetary gears 61, but constantly locks the rotation in both directions transmitted from the planetary gears 61 toward the regular electric motor 2. The second rotation lock mechanism 7 constantly permits (does not lock) the rotation in both directions transmitted from the security electric motor 3 toward the sun gear 60, but constantly locks the rotation in both directions transmitted from the sun gear 60 toward the security electric motor 3. In the strong braking operation, power is transmitted in the planetary gear mechanism 4 from both the planetary gears 61 on the regular electric motor 2 side and the sun gear 60 on the security electric motor 3 side to the internal gear 62 on the speed reducer 20 side. When loosening the braking, a strong force is basically not necessary, and thus the braking may be loosened by the driving force of either one of the regular electric motor 2 and the security electric motor 3.

<Advantageous Effects>

As described above, the brake device 1 for a railway vehicle according to this embodiment includes: an electric motor 2; a speed reducer 20 having an output rotator 21 that outputs a rotational force input from the electric motor 2; a conversion mechanism 30 having an input rotator 31 and a linear motion member 32, the input rotator 31 being configured to receive the rotational force output from the output rotator 21, the linear motion member 32 being configured to convert rotational motion of the input rotator 31 into linear motion in the moving directions VA and VB parallel to the rotational axis of the input rotator 31; and friction members and 40B configured to receive the linear motion of the linear motion member 32 to be pressed against the brake-applied member 41 of the railway vehicle, so as to brake the railway vehicle. The input rotator 31 is movable relative to the output rotator 21 in the moving directions VA and VB and is capable of transmitting the rotational motion of the output rotator 21 to the linear motion member 32.

With this configuration, since the input rotator 31 can move relative to the output rotator 21 in the moving directions VA and VB, the reaction force (brake reaction force) generated when the friction members 40A and 40B are pressed against the brake-applied member 41 does not act on the speed reducer 20. This can lower the possibility of damage to the speed reducer 20 due to the brake reaction force.

The brake device 1 for a railway vehicle according to this embodiment includes: a housing 50 that houses the conversion mechanism 30 such that the linear motion member 32 can move in the moving directions VA and VB; and a reaction force receiving member 51 provided between the housing 50 and the end of the input rotator 31 in one of the moving directions opposite to the direction for pressing the friction members 40A and 40B against the brake-applied member 41, and configured to receive the reaction force acting on the input rotator 31 when the friction members 40A and 40B are pressed against the brake-applied member 41. With this configuration, since the brake reaction force is received by the reaction force receiving member 51, durability against the brake reaction force can be increased.

The input rotator 31 according to the embodiment is a male screw 31. The linear motion member 32 is a female screw 32 that meshes with the male screw 31. The output rotator 21 and the male screw 31 have splines 21a and 31a that engage with each other, such that the output rotator 21 and the male screw 31 are movable relative to each other in the moving directions VA and VB. The rotational motion of the output rotator 21 input via the splines 21a and 31a is transmitted to the male screw 31 and converted into linear motion of the female screw 32. With this configuration, the splines 21a and 31a enables relative movement of the output rotator 21 and the male screw 31 in the moving directions VA and VB and conversion from the rotational motion of the output rotator 21 into the linear motion of the female screw 32.

The output rotator 21 according to the embodiment has a hollow structure. The reaction force receiving member 51 is provided on the end of the male screw 31 that extends through the interior of the hollow structure. This configuration contributes to space savings compared to the case where the reaction force receiving member 51 is provided on the end of the male screw 31 extending through the outside of the hollow structure.

The conversion mechanism 30 according to the embodiment is a ball screw mechanism. With this configuration, the ball screw mechanism enables the conversion from the rotational motion of the male screw 31 into the linear motion of the female screw 32.

The brake device 1 for a railway vehicle includes a security electric motor 3, which is provided separately from the regular electric motor 2 as an electric motor, and a gear mechanism 4 configured to receive the output of the regular electric motor 2 and the output of the security electric motor 3. The gear mechanism 4 includes the first gear to which the output of the regular electric motor 2 is input, the second gear to which the output of the security electric motor 3 is input, and the third gear for outputting to the speed reducer 20 the rotational power input from the first gear or the second gear. With this configuration, the output of the regular electric motor 2 and the output of the security electric motor 3 are input to different gears, thus enabling the braking function driven by the regular electric motor 2 and the braking function driven by the security electric motor 3. Therefore, it is possible to increase the rigidity against the brake reaction force while having redundant braking functions.

The gear mechanism 4 according to the embodiment is a planetary gear mechanism 4 having a sun gear 60, planetary gears 61, and an internal gear 62. The first gear is one of the sun gear 60 and the planetary gears 61. The second gear is the other of the sun gear 60 and the planetary gears 61. The third gear is the internal gear 62. With this configuration, the output of the regular electric motor 2 and the output of the security electric motor 3 are input to the sun gear 60 and the planetary gears 61, which are arranged coaxially, and thus the regular electric motor 2 and the security electric motor 3 can be arranged coaxially. Accordingly, the device can have compact configuration.

In the brake device 1 for a railway vehicle according to the embodiment, the first rotation lock mechanism 6, which can lock the rotation of the first gear, is provided between the regular electric motor 2 and the first gear. The second rotation lock mechanism 7, which can lock the rotation of the second gear, is provided between the security electric motor 3 and the second gear. When the regular electric motor 2 is driven, the first rotation lock mechanism 6 does not lock the rotation of the first gear, while the second rotation lock mechanism 7 locks the rotation of the second gear. When the security electric motor 3 is driven, the first rotation lock mechanism 6 locks the rotation of the first gear, while the second rotation lock mechanism 7 does not lock the rotation of the second gear 60. With this configuration, since driving of one of the regular electric motor 2 and the security electric motor 3 does not cause rotation of the other, the brake can be applied efficiently.

The security electric motors 3 according to the embodiment is a DC electric motor. The regular electric motor 2 is an AC electric motor. The first gear is the planetary gears 61. The second gear is the sun gear 60. The reduction ratio between the sun gear 60 and the internal gear 62 is greater than the reduction ratio between the planetary gears 61 and the internal gear 62. With this configuration, the output of the DC security electric motor is input to the gear with a high reduction ratio, thus avoiding a torque shortage without the need for a larger DC electric motor.

The speed reducer 20 according to the embodiment includes: a case 23 which rotatably retains the input gear 70 configured to receive the output of an electric motor; a crankshaft 24 rotatably supported by the case 23 and having an eccentric region 24a which revolves as the crankshaft 24 receives the rotation of the input gear 70; an oscillating gear 25 having external teeth 25a, the number of the external teeth 25a being smaller than the number of the internal tooth pins 26, the external teeth 25a being meshed with the internal tooth pins 26, the oscillating gear being configured to receive a revolving force from the eccentric region 24a of the crankshaft 24 to rotate oscillatorily; an annular output rotator 21 rotatably supported by the case 23 and having a plurality of pin grooves 21b, which pin grooves 21b are formed in the inner periphery of the output rotator 21 and spaced equally in the circumferential direction; and a plurality of internal tooth pins 26 rotatably retained in the pin grooves 21b of the output rotator 21. This configuration achieves a high rigidity, a high reduction ratio, and a low backlash of the speed reducer 20 which ensure stability and responsiveness of the braking force.

### Second Embodiment

<Brake Device for Railway Vehicle>

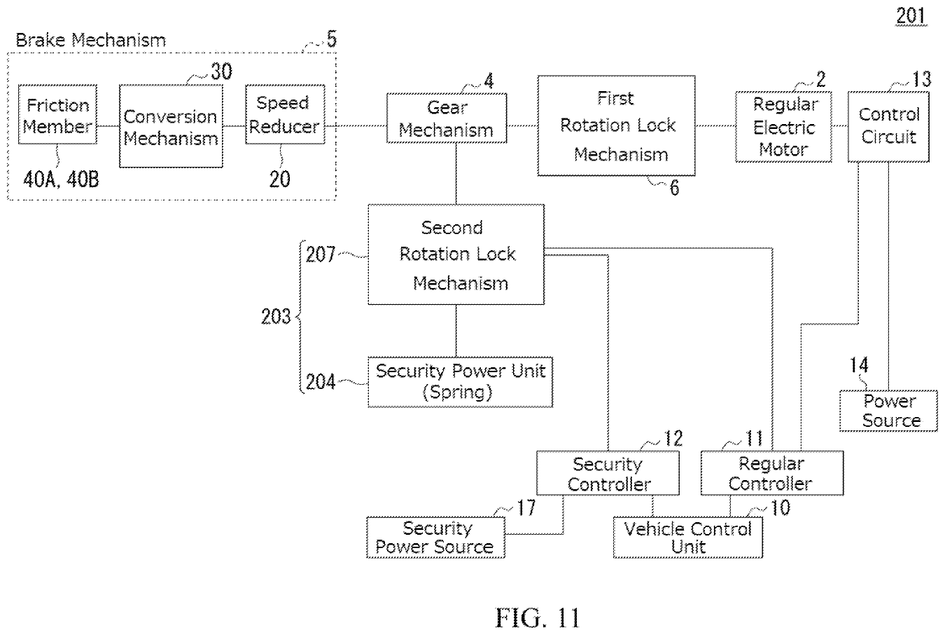

FIG. 11 is a block diagram showing a brake device 201 for a railway vehicle according to a second embodiment. In the first embodiment described above, the security power unit is a DC electric motor, but this example is not limitative. For example, the security power unit may be a spring cylinder. As shown in FIG. 11, the security power unit 203 of the second embodiment includes a spring 204 and a retention mechanism 207 that retains the spring 204 in a biased state. The first and second embodiments have some common features, which have the same name and will not be described in detail.

For example, the regular controller 11 controls the rotational drive of the regular electric motor 2 via the control circuit 13. For example, the regular controller 11 controls the second rotation lock mechanism 207 (an example of the retention mechanism) included in the security power unit 203. For example, the security controller 12 controls the second rotation lock mechanism 207 included in the security power unit 203. The spring 204 included in the security power unit 203 serves as a drive energy source for the security braking and the parking braking in the event of power loss. For example, the spring 204 is a spiral spring.

In this embodiment, the output shaft of the regular electric motor 2 (AC electric motor) is connected to the sun gear 60 via the first rotation lock mechanism 6. The output shaft of the security power unit 203 (spring 204) is connected to the planetary carrier 63 (planetary gears 61) via the second rotation lock mechanism 207. The speed reducer 20 is connected to the external gear 64 via the input gear 70.

<Example of Braking Operation>

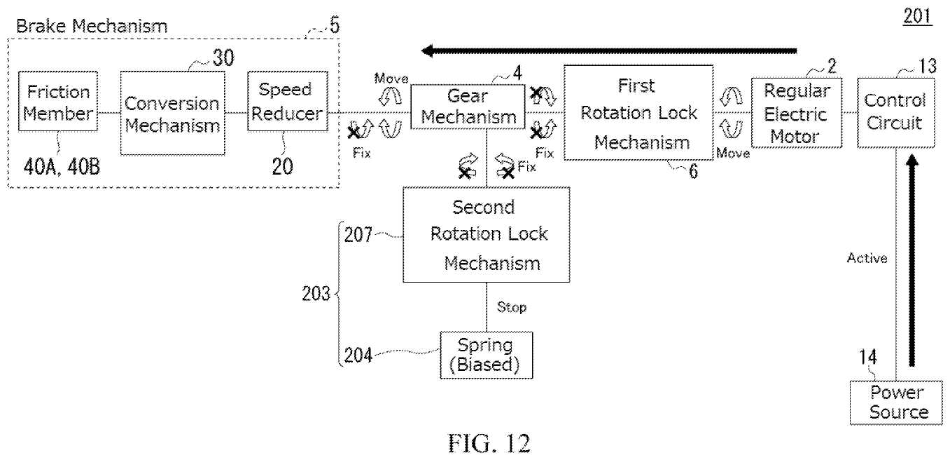

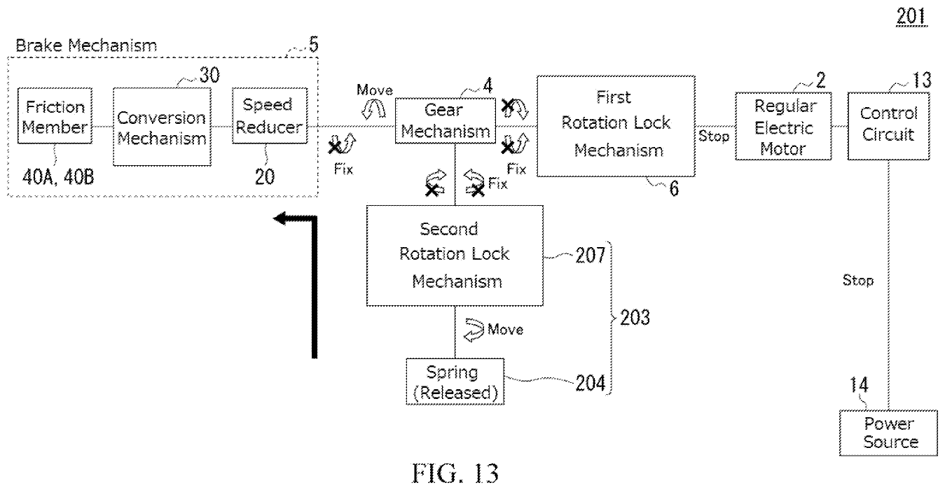

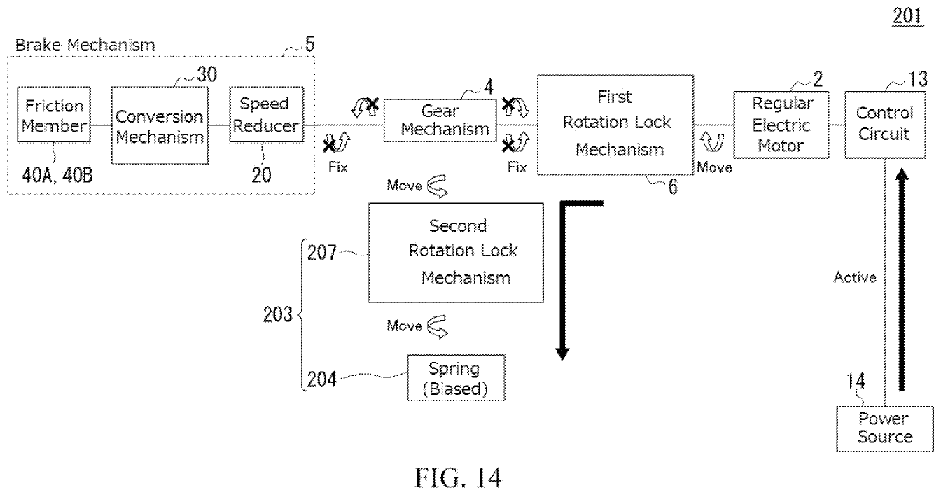

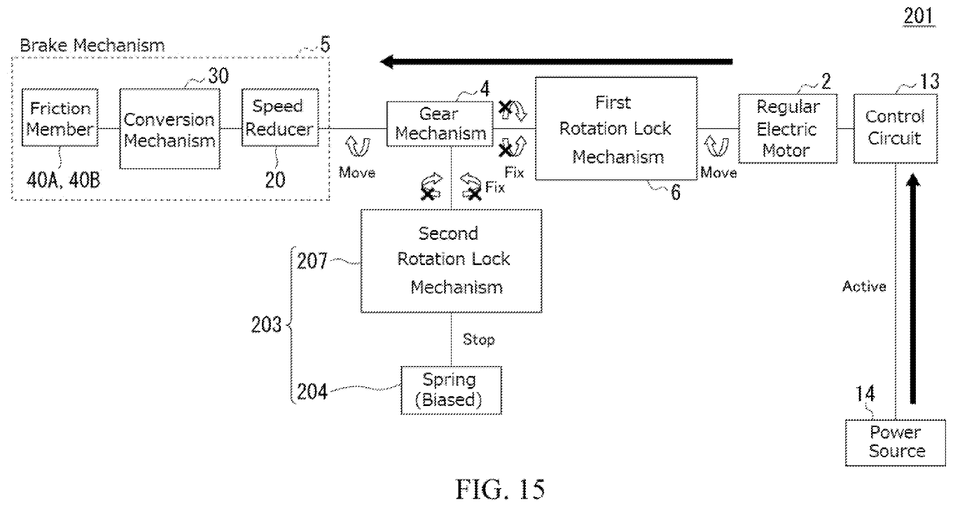

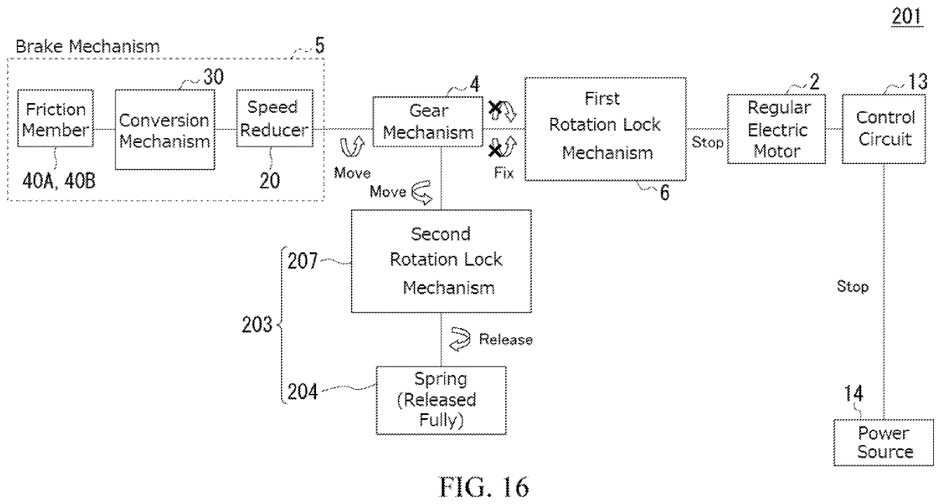

Next, an example of braking operation of the brake device for a railway vehicle according to the second embodiment is described with reference to FIGS. 12 to 16. FIG. 12 illustrates an operation of normal braking according to the second embodiment. FIG. 13 illustrates an operation of security braking according to the second embodiment. FIG. 14 illustrates an operation of energy charging according to the second embodiment. FIG. 15 illustrates a return operation according to the second embodiment. FIG. 16 illustrates an operation of manually releasing the parking braking according to the second embodiment. FIGS. 12 to 10 do not show the components such as the vehicle control unit 10 shown in FIG. 11.

<Normal Braking>

As shown in FIG. 12, in the normal braking operation, the regular electric motor 2 is driven. In the normal braking operation, the power source 14 supplies power to the control circuit 13 for the regular electric motor 2. In the normal braking operation, the security power unit 203 is not driven. In the normal braking operation, the spring 204 of the security power unit 203 is retained in a biased state so that it can operate in an emergency.

When the regular electric motor 2 is driven, the first rotation lock mechanism 6 does not lock the rotation of the sun gear 60, while the second rotation lock mechanism 207 locks the rotation of the planetary gears 61. The regular electric motor 2 is capable of forward and reverse rotation with the supplied electric power.

The forward and reverse rotation of the regular electric motor 2 is transmitted to the brake mechanism 5 through the first rotation lock mechanism 6 and the planetary gear mechanism 4. For example, in the normal braking operation, forward rotation of the regular electric motor 2 tightens the braking, and reverse rotation thereof loosens the braking.

The first rotation lock mechanism 6 constantly permits (does not lock) the rotation in both directions transmitted from the regular electric motor 2 toward the sun gear 60, but constantly locks the rotation in both directions transmitted from the sun gear 60 toward the regular electric motor 2. The second rotation lock mechanism 207 constantly locks the rotation in both directions transmitted from the planetary gears 61 toward the security power unit 203. In the normal braking operation, power is transmitted in the planetary gear mechanism 4 from the sun gear 60 on the regular electric motor 2 side to the internal gear 62 on the speed reducer 20 side, with the planetary gears 61 on the security power unit 203 side fixed. In the normal braking operation, to retain the braking (such as for parking braking), the regular electric motor 2 is stopped with a predetermined amount of braking force applied.

<Security Braking>

As shown in FIG. 13, in the security braking operation, the security power unit 203 is driven. In the security braking operation, the spring 204 of the security power unit 203 is released from the biased state. In the security braking operation, the regular electric motor 2 is not driven. In the security braking operation, the power source 14 does not supply power to the control circuit 13 for the regular electric motor 2.

When the spring 204 is released from the biased state, the first rotation lock mechanism 6 locks the rotation of the sun gear 60, while the second rotation lock mechanism 207 does not lock the rotation of the planetary gears 61. The security power unit 203 is capable of rotating in one direction when the spring 204 is released from the biased state. The rotation in one direction of the security power unit 203 is the rotation in one direction around the output shaft of the security power unit 203.

The rotation in one direction of the security power unit 203 is transmitted to the brake mechanism 5 through the second rotation lock mechanism 207 and the planetary gear mechanism 4. For example, in the security braking operation, the rotation in one direction of the security power unit 203 tightens the braking (applies the braking force).

The first rotation lock mechanism 6 constantly locks the rotation in both directions transmitted from the sun gear 60 toward the regular electric motor 2. The second rotation lock mechanism 207 constantly permits (does not lock) the rotation in one direction transmitted from the security power unit 203 toward the planetary gears 61, but constantly locks the rotation in both directions transmitted from the planetary gears 61 toward the security power unit 203. In the security braking operation, power is transmitted in the planetary gear mechanism 4 from the planetary gears 61 on the security power unit 203 side to the internal gear 62 on the speed reducer 20 side, with the sun gear 60 on the regular electric motor 2 side fixed. In the security braking operation, to retain the braking (such as for parking braking), the security power unit 203 (e.g., the second rotation lock mechanism 207) is stopped with a predetermined amount of braking force applied.

<Energy Charging>

As shown in FIG. 14, in the operation of energy charging, the regular electric motor 2 is driven. In the operation of energy charging, the power source 14 supplies power to the control circuit 13 for the regular electric motor 2. In the operation of energy charging, the spring 204 is put into a biased state. This allows the security power unit 203 to be driven in an emergency.

In the operation of energy charging, the vehicle control unit 10 puts the spring 204 into the biased state by driving the regular electric motor 2 while controlling the first rotation lock mechanism 6 and the second rotation lock mechanism 207 so as not to lock the rotation of the sun gear 60 and planetary gears 61. The regular electric motor 2 is capable of forward rotation or reverse rotation (the rotation in the braking direction) with the supplied electric power.

The forward rotation or the reverse rotation (the rotation in the braking direction) of the regular electric motor 2 is transmitted to the brake mechanism 5 through the first rotation lock mechanism 6 and the planetary gear mechanism 4. In the operation of energy charging, the rotation in the braking direction of the regular electric motor 2 tightens the braking (applies the braking force).

The first rotation lock mechanism 6 constantly permits (does not lock) the forward or reverse rotation transmitted from the regular electric motor 2 toward the sun gear 60, but constantly locks the rotation in both directions transmitted from the sun gear 60 toward the regular electric motor 2. The second rotation lock mechanism 207 constantly permits (does not lock) the rotation in both directions of the planetary gears 61. In the operation of energy charging, power is transmitted in the planetary gear mechanism 4 from the sun gear 60 on the regular electric motor 2 side to the internal gear 62 on the speed reducer 20 side, with the rotation of the planetary gears 61 on the security power unit 203 side permitted.

As the regular electric motor 2 rotates in the braking direction, the friction members 40A and 40B are pressed against the brake-applied member 41 (e.g., the brake-applied member 41 is sandwiched between the pair of friction members 40A and 40B), and then the friction members 40A and 40B do not advance any further. In the operation of energy charging, the planetary gears 61 are free to rotate, and thus the spring 204 is subjected to a force in the direction opposite to the braking direction. In other words, the driving force of the regular electric motor 2 causes the spring 204 to rotate in the biasing direction (charging direction). As a result, the spring 204 returns to its original position (biased position).

In the operation of energy charging, a sensor may be used to sense the force of the spring 204 or the electric current value of the regular electric motor 2. For example, the vehicle control unit 10 may stop the spring 204 at a predetermined position to prevent the spring 204 from being biased excessively, based on the sensing results of the force of the spring 204 and the electric current value of the regular electric motor 2.

<Return Operation>

As shown in FIG. 15, in the return operation, the regular electric motor 2 is driven. The return operation is to move the friction members 40A and 40B away from the brake-applied member 41. In the return operation, the power source 14 supplies power to the control circuit 13 for the regular electric motor 2. In the return operation, the spring 204 is put into a biased state. This allows the security power unit 203 to be driven in an emergency.

When the regular electric motor 2 is driven, the first rotation lock mechanism 6 does not lock the rotation of the sun gear 60, while the second rotation lock mechanism 207 locks the rotation of the planetary gears 61. The regular electric motor 2 is capable of forward rotation or reverse rotation (the rotation in the loosening direction) with the supplied electric power. The rotation in the loosening direction is the rotation in the opposite direction to the braking direction.

The forward rotation or the reverse rotation (the rotation in the loosening direction) of the regular electric motor 2 is transmitted to the brake mechanism 5 through the first rotation lock mechanism 6 and the planetary gear mechanism 4. For example, in the return operation, the rotation in the loosening direction of the regular electric motor 2 loosens the braking (releases the braking force).

The first rotation lock mechanism 6 constantly permits (does not lock) the forward or reverse rotation transmitted from the regular electric motor 2 toward the sun gear 60, but constantly locks the rotation in both directions transmitted from the sun gear 60 toward the regular electric motor 2. The second rotation lock mechanism 207 constantly locks the rotation in both directions transmitted from the planetary gears 61 toward the security power unit 203. In the return operation, power is transmitted in the planetary gear mechanism 4 from the sun gear 60 on the regular electric motor 2 side to the internal gear 62 on the speed reducer 20 side, with the planetary gears 61 on the security power unit 203 side fixed. In the return operation, after the braking is loosened (after the friction members 40A and 40B are moved away from the brake-applied member 41), the regular electric motor 2 is stopped.

<Manual Releasing of Parking Braking>

As shown in FIG. 16, in the operation of manually releasing the parking braking, the rotating shaft of the security power unit 203 is disconnected manually. In the operation of manually releasing the parking braking, the spring 204 of the security power unit 203 is released fully from the biased state. In the operation of manually releasing the parking braking, the regular electric motor 2 is not driven. In the operation of manually releasing the parking braking, the power source 14 does not supply power to the control circuit 13 for the regular electric motor 2.

When the spring 204 is released fully from the biased state, the first rotation lock mechanism 6 locks the rotation of the sun gear 60, while the second rotation lock mechanism 207 does not lock the rotation of the planetary gears 61. The security power unit 203 is capable of rotating in one direction when the spring 204 is released fully from the biased state. In the operation of manually releasing the parking braking, the rotating shaft of the security power unit 203 is disconnected, and thus the rotation in one direction of the spring 204 does not act on the brake mechanism 5. In the operation of manually releasing the parking braking, the braking is loosened because the reaction force acting on the brake mechanism 5 is released.

For example, in the operation of manually releasing the parking braking, a spring clutch or other means may be used to disconnect the rotating shaft of the security power unit 203. For example, the braking may be loosened by turning a mechanical switch by hand while the parking braking is applied. For example, the output shaft of the security power unit 203 may be turned with a wrench or other tool. For example, the shaft may be disconnected between the second rotation lock mechanism 207 and the planetary gears 61. After manually releasing the parking braking, charging is performed (spring 204 is retained in a biased state) when the power is turned on.

<Advantageous Effects>

As described above, the security power unit 203 according to the embodiment includes a spring 204 and a retention mechanism 207 that retains the spring 204 in a biased state. The first gear to which the output of the regular electric motor 2 is input is the sun gear 60. The second gear to which the output of the security power unit 203 is input is the planetary gears 61. The reduction ratio between the sun gear 60 and the internal gear 62 is greater than the reduction ratio between the planetary gears 61 and the internal gear 62. When a spring force is input to gears with a high reduction ratio, the amount of stroke of the spring is large. Since springs rotate slower than electric motors, they are likely to require more time for security braking. By contrast, in this embodiment, the spring force (the force of spring 204) is input to the gears with a low reduction ratio, and thus the above problem can be avoided.

In the brake device 201 for a railway vehicle according to the embodiment, the first rotation lock mechanism 6, which can lock the rotation of the first gear, is provided between the regular electric motor 2 and the first gear. The retention mechanism 207 is the second rotation lock mechanism 207 that can lock the rotation of the second gear. The brake device 201 for a railway vehicle includes a vehicle control unit 10 that controls the first rotation lock mechanism 6, the second rotation lock mechanism 207, and the regular electric motor 2. The vehicle control unit 10 puts the spring 204 into the biased state by driving the regular electric motor 2 while controlling the first rotation lock mechanism 6 and the second rotation lock mechanism 207 so as not to lock the rotation of the first gear and the second gear. With this configuration, the spring 204 can be put into the biased state under the control of the vehicle control unit 10 (automatically), without manual application of a force.

### Third Embodiment

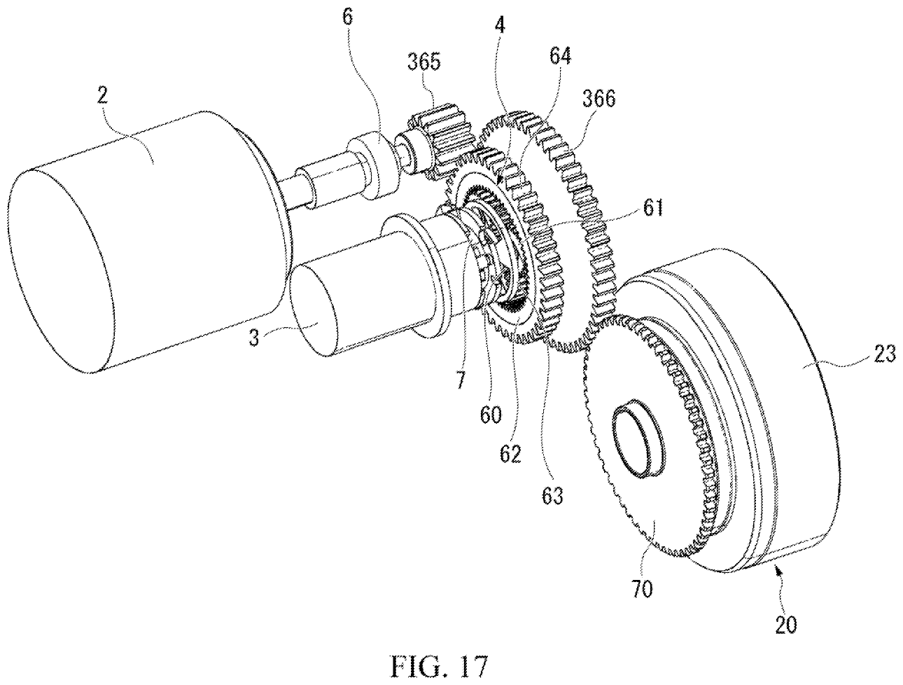

FIG. 17 is a perspective view showing the connection between the gear mechanism 4 and the speed reducer 20 according to the third embodiment. In the first embodiment described above, the regular electric motor 2 and the security electric motor 3 are positioned coaxially with each other, but this example is not limitative. For example, as shown in FIG. 17, the regular electric motor 2 and the security electric motor 3 may be positioned on different axes from each other. The first and third embodiments have some common features, which have the same name and will not be described in detail.

As shown in FIG. 17, the output shaft of the regular electric motor 2 and the output shaft of the security electric motor 3 are parallel with each other. A pinion 365 is provided on the output shaft of the regular electric motor 2 via the first rotation lock mechanism 6. The external gear 64 and an intermediate gear 366 having a larger diameter than the external gear 64 are provided on the outer periphery of the internal gear 62.

The output shaft of the regular electric motor 2 according to this embodiment is connected to the external gear 64 via the first rotation lock mechanism 6 and the pinion 365. The output shaft of the security electric motor 3 is connected to the sun gear 60 via the second rotation lock mechanism 7. The speed reducer 20 is connected to the intermediate gear 366 via the input gear 70. With this configuration, addition of the gears allows the regular electric motor 2, the security electric motor 3, and the speed reducer 20 to be arranged in parallel with each other.

### Fourth Embodiment

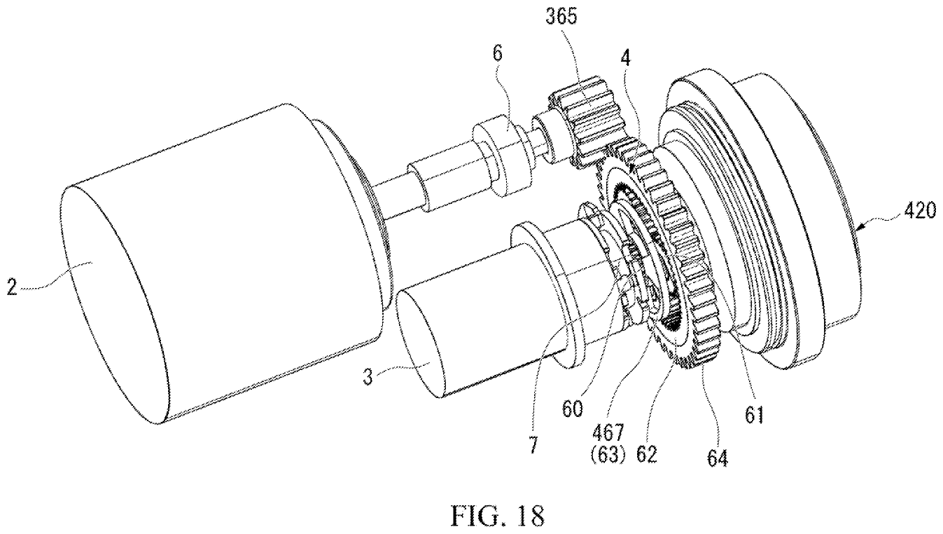

FIG. 18 is a perspective view showing the connection between the gear mechanism 4 and the speed reducer 420 according to the fourth embodiment. In the first embodiment described above, the speed reducer 20 has a hollow structure, but this example is not limitative. For example, as shown in FIG. 18, it is also possible that the speed reducer 420 does not have a hollow structure. The first, third, and fourth embodiments have some common features, which have the same name and will not be described in detail.

As shown in FIG. 18, the speed reducer 420 is a solid speed reducer with a solid structure. The output shaft of the regular electric motor 2 and the output shaft of the security electric motor 3 are parallel with each other. The output shaft of the security electric motor 3 and the central shaft of the speed reducer 420 are coaxial with each other. A carrier shaft 467 is coupled to the planetary gears 61.

The output shaft of the regular electric motor 2 according to this embodiment is connected to the external gear 64 via the first rotation lock mechanism 6 and the pinion 365. The output shaft of the security electric motor 3 is connected to the sun gear 60 via the second rotation lock mechanism 7. The central shaft of the speed reducer 420 is coupled to the carrier shaft 467, which is the shaft of the carrier 63. This configuration eliminates the need for the input gear 70 and the intermediate gear 366, thus reducing the number of gears.

### Fifth Embodiment

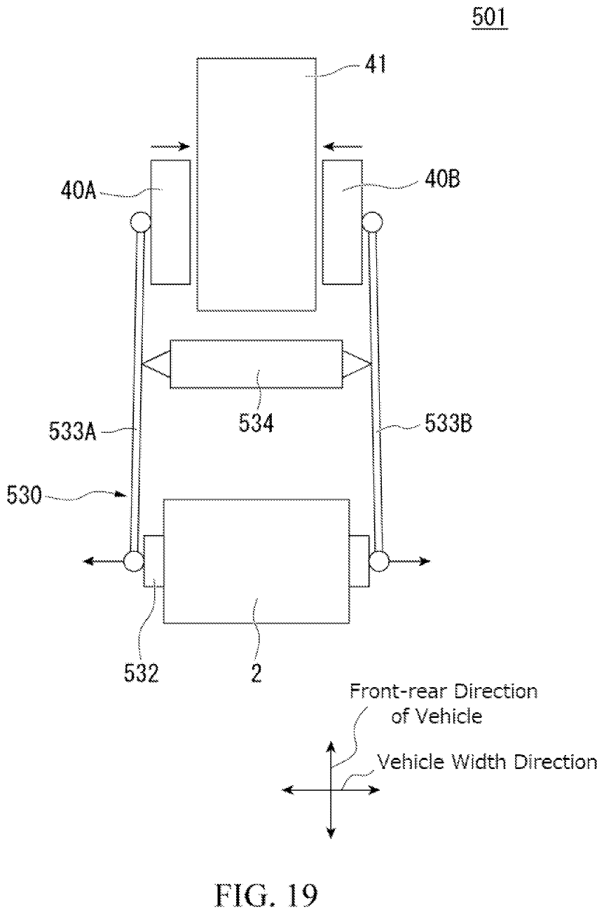

FIG. 19 is a schematic diagram showing a point-of-effort driven configuration according to a fifth embodiment. In the first embodiment described above, the electric motor 2 and the linear motion member 32 are positioned on different axes, but this example is not limitative. For example, as shown in FIG. 19, the electric motor 2 and a linear motion member 532 may be positioned coaxially with each other. The first, third, and fifth embodiments have some common features, which have the same name and will not be described in detail.

As shown in FIG. 19, the brake device 501 for a railway vehicle includes a conversion mechanism 530 that converts the rotational force output from the electric motor 2 into linear motion. The conversion mechanism 530 includes the linear motion member 532, a pair of arms 533A and 533B spaced apart in the vehicle width direction, and a coupling member 534 that couples the pair of arms 533A and 533B. Of the pair of arms 533A and 533B, the arm 533A on one side in the vehicle width direction is hereinafter also referred to as “the first arm 533A,” and the arm 533B on the other side in the vehicle width direction as “the second arm 533B.”

The first arm 533A extends along the front-rear direction of the vehicle so as to connect between one end of the linear motion member 532 and the first friction member 40A. The first arm 533A has a length along the front-rear direction of the vehicle. One end of the first arm 533A in its longitudinal direction is coupled to one end of the linear motion member 532 via a universal joint or the like. The other end of the first arm 533A in its longitudinal direction is coupled to the first friction member 40A via a universal joint or the like.

The second arm 533B extends along the front-rear direction of the vehicle so as to connect between the other end of the linear motion member 532 and the second friction member 40B. The second arm 533B has a length along the front-rear direction of the vehicle. One end of the second arm 533B in its longitudinal direction is coupled to the other end of the linear motion member 532 via a universal joint or the like. The other end of the second arm 533B in its longitudinal direction is coupled to the second friction member 40B via a universal joint or the like.

The coupling member 534 extends along the vehicle width direction so as to connect between the pair of arms 533A and 533B. The coupling member 534 has a length along the vehicle width direction. One end of the coupling member 534 in its longitudinal direction is coupled to the middle portion of the first arm 533A in its longitudinal direction so as to be swingable relative to this middle portion of the first arm 533A. The other end of the coupling member 534 in its longitudinal direction is coupled to the middle portion of the second arm 533B in its longitudinal direction so as to be swingable relative to this middle portion of the second arm 533B.

For example, when the rotational force output from the electric motor 2 is converted into linear motion of the linear motion member 532, the linear motion of the linear motion member 532 is transmitted to the friction members 40A and 40B via the arms 533A and 533B and the coupling member 534. The arms 533A and 533B move in such a direction that the ends thereof coupled to the friction members 40A and 40B come closer to each other using the coupling member 534 as a fulcrum. As a result, the friction members 40A and 40B are pressed against the brake-applied member 41. Thus, the railway vehicle is braked.

The brake device 501 for a railway vehicle according to this embodiment has a point-of-effort driven configuration. When the friction members 40A and 40B are worn by friction with the brake-applied member 41, gaps are created between the friction members 40A, 40B and the brake-applied member 41. Therefore, a gap adjuster is required to adjust the gaps, and the structure is likely to be more complex. By contrast, with this configuration, even if the friction members 40A and 40B are worn, the gaps between the friction members 40A, 40B and the brake-applied member 41 can be adjusted to a constant amount by the electric motor 2. In addition, since the electric motor 2 also serves as the gap adjuster, the structure can be simplified.

### Sixth Embodiment

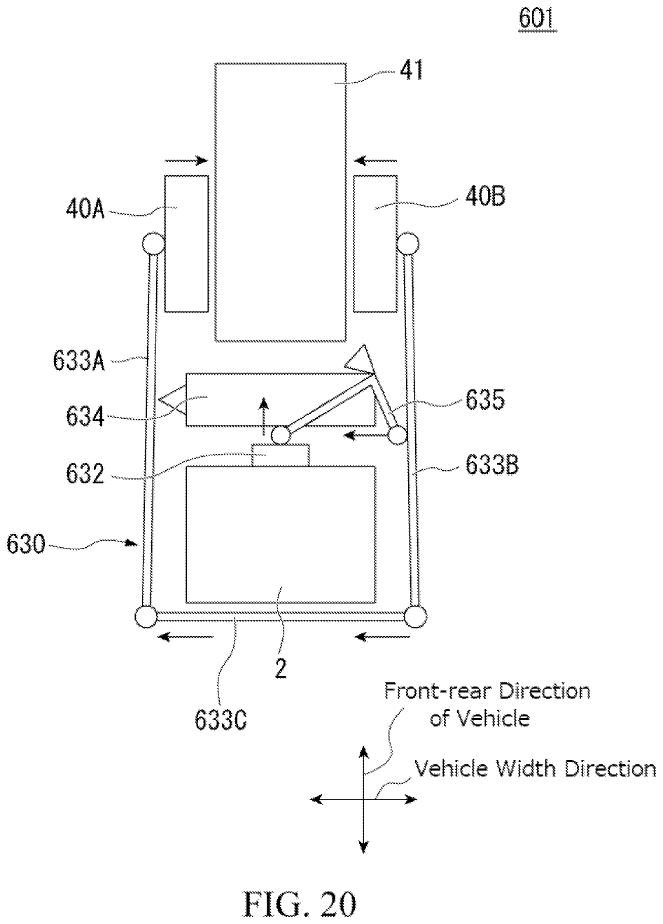

FIG. 20 is a schematic diagram showing a fulcrum driven configuration according to a sixth embodiment. The fifth embodiment described above has a point-of-effort driven configuration, but this example is not limitative. For example, as shown in FIG. 20, a brake device 601 for a railway vehicle may have a fulcrum driven configuration. The first, fifth, and sixth embodiments have some common features, which have the same name and will not be described in detail.

As shown in FIG. 20, the brake device 601 for a railway vehicle includes a conversion mechanism 630 that converts the rotational force output from the electric motor 2 into linear motion. The conversion mechanism 630 includes a linear motion member 632, a first arm 633A and a second arm 633B spaced apart in the vehicle width direction, a third arm 633C extending along the vehicle width direction to connect the first arm 633A and the second arm 633B, a fulcrum member 634 supporting the first arm 633A, and a link mechanism 635 connected to the fulcrum member 634.

The first arm 633A extends along the front-rear direction of the vehicle so as to connect between one end of the third arm 633C and the first friction member 40A. The first arm 633A has a length along the front-rear direction of the vehicle. One end of the first arm 633A in its longitudinal direction is coupled to one end of the third arm 633C via a universal joint or the like. The other end of the first arm 633A in its longitudinal direction is coupled to the first friction member 40A via a universal joint or the like.

The second arm 633B extends along the front-rear direction of the vehicle so as to connect between the other end of the third arm 633C and the second friction member 40B. The second arm 633B has a length along the front-rear direction of the vehicle. One end of the second arm 633B in its longitudinal direction is coupled to the other end of the third arm 633C via a universal joint or the like. The other end of the second arm 633B in its longitudinal direction is coupled to the second friction member 40B via a universal joint or the like.

The fulcrum member 634 extends in the vehicle width direction. The fulcrum member 634 has a length along the vehicle width direction. One end of the fulcrum member 634 in its longitudinal direction is coupled to the middle portion of the first arm 633A in its longitudinal direction so as to be swingable relative to this middle portion of the first arm 633A.

The link mechanism 635 is L-shaped. One end of the link mechanism 635 is coupled to one end of the linear motion member 632 via a universal joint or the like. The other end of the link mechanism 635 is coupled to the middle portion of the second arm 633B in its longitudinal direction via a universal joint or the like. The bending portion of the link mechanism 635 is connected to the other end of the fulcrum member 634 in its longitudinal direction via a universal joint or the like.

For example, when the rotational force output from the electric motor 2 is converted into linear motion of the linear motion member 632, the linear motion of the linear motion member 632 is transmitted to the friction members 40A and 40B via the arms 633A, 633B, and 633C, the fulcrum member 634, and the link mechanism 635. The first arm 633A moves in such a direction that the end thereof coupled to the first friction member 40A comes closer to the brake-applied member 41 using the fulcrum member 634 as a fulcrum. By the operation of the link mechanism 635, the second arm 633B moves in such a direction that the end thereof coupled to the second friction member 40B comes closer to the brake-applied member 41. As a result, the friction members 40A and 40B are pressed against the brake-applied member 41. Thus, the railway vehicle is braked.

The brake device 601 for a railway vehicle according to this embodiment has a fulcrum driven configuration. This configuration may additionally employ a gap adjuster such that, even if the friction members 40A and 40B are worn, the gaps between the friction members 40A, 40B and the brake-applied member 41 can be adjusted to a constant amount.

### Seventh Embodiment

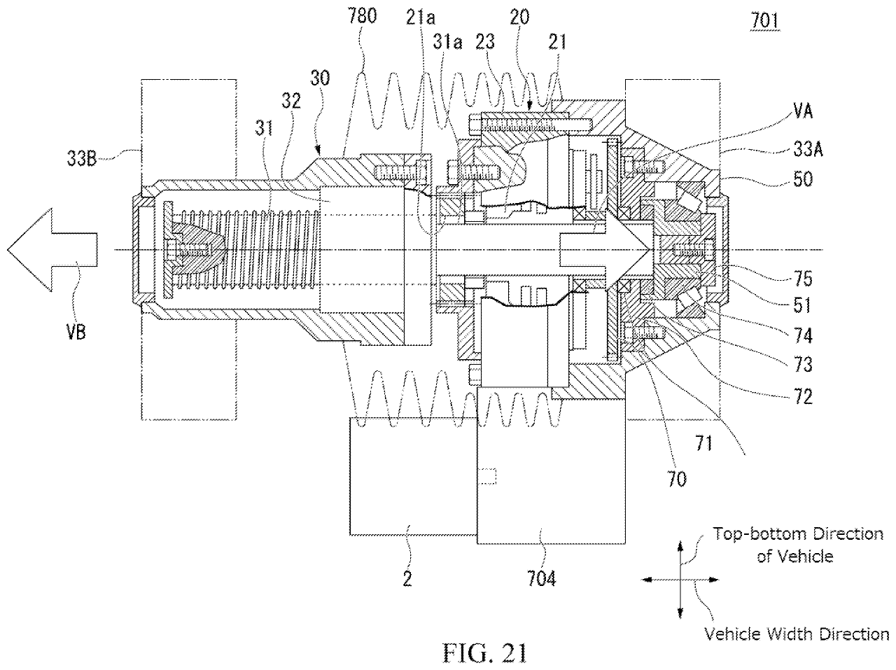

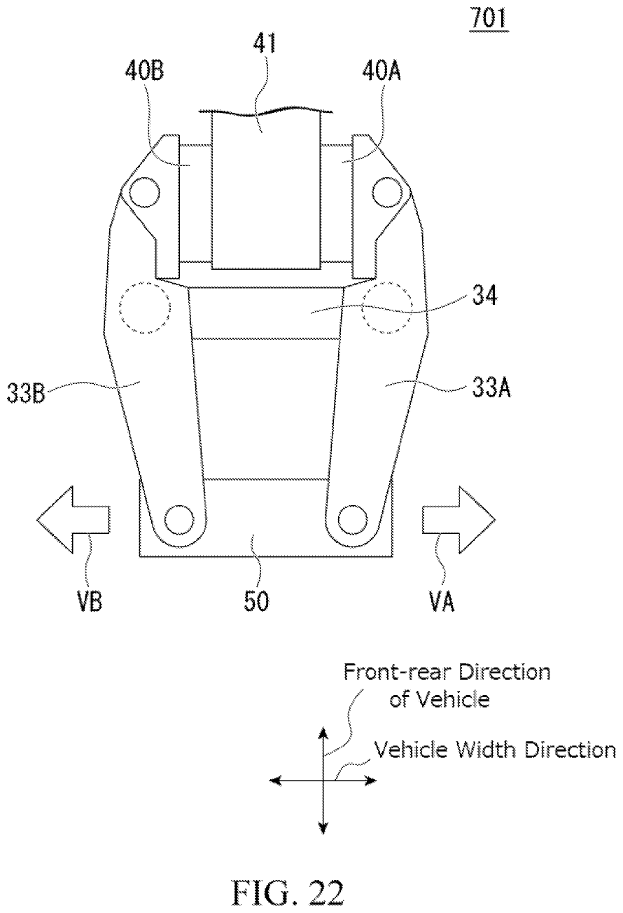

FIG. 21 is a cross-sectional view schematically showing a brake device for a railway vehicle according to a seventh embodiment. FIG. 22 is a schematic diagram showing an example of application of a disc braking system according to the seventh embodiment. In the first embodiment described above, the brake device includes the regular electric motor 2 and the security electric motor 3, but this example is not limitative. For example, as shown in FIG. 21, the security electric motor 3 may be omitted. The first embodiment and the seventh embodiment (FIGS. 21 and 22) have some common features, which have the same name and will not be described in detail.

A brake device 701 for a railway vehicle according to this embodiment includes a regular electric motor 2 (an example of an electric motor), a transmission mechanism 704, a speed reducer 20, a conversion mechanism 30, friction members and 40B, a vehicle control unit 10 (an example of a control unit), and a regular controller 11. FIGS. 21 and 22 do not show the components such as the vehicle control unit 10 shown in FIG. 1.

The regular electric motor 2 is disposed along the vehicle width direction. The regular electric motor 2 has an output shaft projecting toward one side in the vehicle width direction. The output shaft of the regular electric motor 2 is connected to the transmission mechanism 704. The transmission mechanism 704 is provided between the regular electric motor 2 and the speed reducer 20. The transmission mechanism 704 transmits to the speed reducer 20 the rotational power input from the regular electric motor 2. For example, the transmission mechanism 704 may include a first transmission gear to which the output of the regular electric motor 2 is input, a second transmission gear that meshes with the input gear 70 on the speed reducer 20 side, and a third transmission gear that meshes with the first and second transmission gears.

The speed reducer 20 includes an output rotator 21 that outputs the rotational force input from the regular electric motor 2 via the transmission mechanism 704. The output rotator 21 has a hollow structure. The output rotator 21 has a tubular shape extending along the vehicle width direction. The speed reducer is connected to the transmission mechanism 704 via the input gear 70.

In this embodiment, the output shaft of the regular electric motor 2 is connected to the speed reducer 20 via the transmission mechanism 704 and the input gear 70. The speed reducer 20 includes a tubular case 23 that rotatably retains the input gear 70. In this embodiment, the regular electric motor 2, the transmission mechanism 704, the input gear 70, and the speed reducer 20 have an integrated motor-and-reducer configuration.

As shown in FIG. 22, a pair of friction members 40A and 40B are arranged in the vehicle width direction so as to sandwich a brake-applied member 41 of the railway vehicle. The linear motion of the female screw 32 in the moving directions VA and VB is transmitted to the friction members 40A and 40B. As a result, the friction members 40A and 40B are pressed against the brake-applied member 41 to brake the railway vehicle.

The brake-applied member 41 is a disc attached to the axle of the railway vehicle. The pair of friction members 40A and 40B constitute a disc brake unit (DBU) that sandwiches the disc on both sides (disc braking system).

The housing 50 encloses the reaction force receiving member 51, the retaining bearing 71, the bearing support member 72, the spacer 73, the tapered roller bearing 74, and the lid member 75. In this embodiment, the housing 50 and the conversion mechanism 30 are partly covered by a cover 780 having a bellows structure. The cover 780 is capable of expanding and contracting along the moving directions VA and VB of the female screw 32.

For example, the output of the regular electric motor 2 is input to the input gear 70 via the transmission mechanism 704. Then a decelerated rotational force is output from the output rotator 21 of the speed reducer 20. The rotational force output from the output rotator 21 is then input to the male screw 31. As described above, the output rotator 21 and the male screw 31 have splines 21a and 31a that engage with each other, such that the output rotator 21 and the male screw 31 are movable relative to each other in the moving directions VA and VB. The rotational motion of the output rotator 21 input via the splines 21a and 31a is transmitted to the male screw 31. The rotational motion of the male screw 31 is converted into a linear motion of the female screw 32 in the moving directions VA and VB.

The linear motion of the female screw 32 in the moving directions VA and VB is transmitted to the friction members 40A and 40B via the arms 33A and 33B and the coupling member 34. The arms 33A and 33B move in such a direction that the ends thereof coupled to the friction members 40A and 40B come closer to each other using the coupling member 34 as a fulcrum. As a result, the friction members and 40B are pressed against the brake-applied member 41. Thus, the railway vehicle is braked.

In the brake device for a railway vehicle according to this embodiment, the regular electric motor 2 is connected to the speed reducer 20 via the transmission mechanism 704. This arrangement in the integrated motor-and-reducer configuration can lower the possibility of damage to the speed reducer 20 due to the brake reaction force.

### Eighth Embodiment

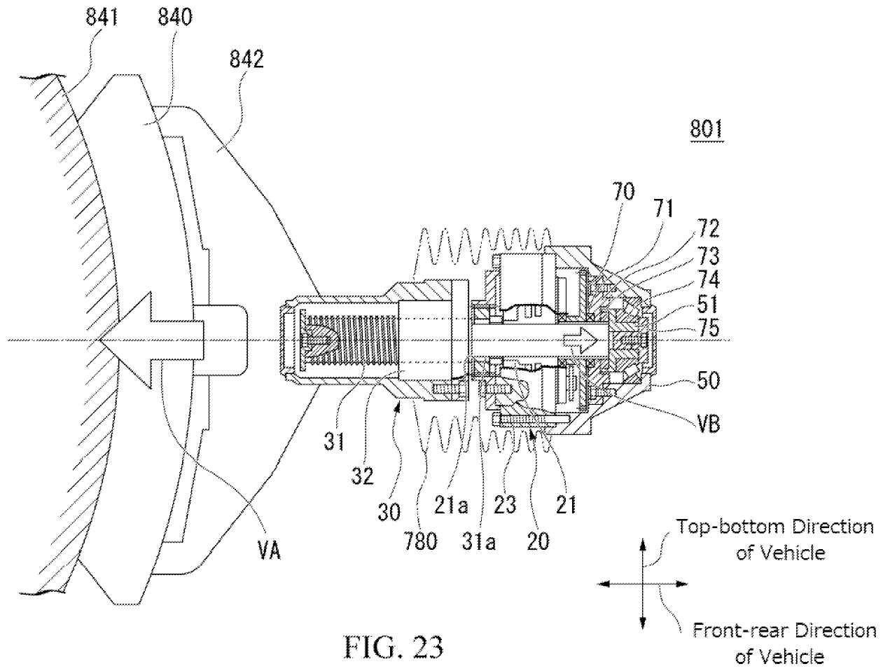

FIG. 23 is a schematic diagram showing an example of application of a wheel tread braking system according to an eighth embodiment. In the seventh embodiment described above, the pair of friction members 40A and 40B constitute a disc brake unit (DBU) that sandwiches the disc as the brake-applied member on both sides (disc braking system), but this example is not limitative. For example, as shown in FIG. 23, a tread brake unit (TBU) may be provided, in which a friction member is pressed against the tread of a wheel 841 as the brake-applied member on one side (wheel tread braking system). The first and seventh embodiments and the eighth embodiment (FIG. 23) have some common features, which have the same name and will not be described in detail.

A brake device 801 for a railway vehicle according to this embodiment includes a regular electric motor 2 (an example of an electric motor), a transmission mechanism 704, a speed reducer 20, a conversion mechanism 30, a brake shoe 840 (an example of a friction member), a vehicle control unit 10 (an example of a control unit), and a regular controller 11. FIG. 23 does not show the components such as the vehicle control unit 10 shown in FIG. 1 and the regular electric motor 2 and the transmission mechanism 704 shown in FIG. 21.

Similarly to the seventh embodiment, the regular electric motor 2, the transmission mechanism 704, the input gear 70, and the speed reducer 20 in this embodiment have an integrated motor-and-reducer configuration. In this embodiment, the conversion mechanism 30 (an input rotator 31 to which the rotational force output from the output rotator 21 is input, and a linear motion member 32 that converts the rotational motion of the input rotator 31 into linear motion in the moving directions VA and VB parallel to the rotation axis of the input rotator 31) is disposed along the front-rear direction of the vehicle.

The brake shoe 840 is provided on one of the surfaces of the wheel 841 (an example of a brake-applied member) of the railway vehicle, the surfaces facing the front-rear direction of the vehicle. The linear motion of the female screw 32 in the moving direction VA (opposite to the moving direction VB) is transmitted to the brake shoe 840. As a result, the brake shoe 840 is pressed against the brake-applied member 841 to brake the railway vehicle.

The brake-applied member 841 is a wheel of the railway vehicle. The brake shoe 840 constitutes a tread brake unit (TBU), in which the brake shoe 840 is pressed against the tread of the wheel 841 as the brake-applied member on one side (wheel tread braking system). A shoe head 842 is attached to the portion of the brake shoe 840 opposite to the wheel 841. The middle portion of the shoe head 842 in the top-bottom direction of the vehicle is coupled to the end of the female screw 32 opposite to the speed reducer 20.

For example, the output of the regular electric motor 2 is input to the input gear 70 via the transmission mechanism 704. Then a decelerated rotational force is output from the output rotator 21 of the speed reducer 20. The rotational force output from the output rotator 21 is then input to the male screw 31. As described above, the output rotator 21 and the male screw 31 have splines 21a and 31a that engage with each other, such that the output rotator 21 and the male screw 31 are movable relative to each other in the moving directions VA and VB. The rotational motion of the output rotator 21 input via the splines 21a and 31a is transmitted to the male screw 31. The rotational motion of the male screw 31 is converted into a linear motion of the female screw 32 in the moving directions VA and VB.

The linear motion of the female screw 32 in the moving direction VA (opposite to the moving direction VB) is transmitted to the brake shoe 840 via the shoe head 842. As a result, the brake shoe 840 is pressed against the brake-applied member 841. Thus, the railway vehicle is braked.

The brake device 801 for a railway vehicle according to this embodiment constitutes a tread brake unit (TBU), in which the brake shoe 840 is pressed against the tread of the wheel 841 as the brake-applied member on one side. This arrangement in the wheel tread braking system can lower the possibility of damage to the speed reducer 20 due to the brake reaction force.

The technical scope of the present invention is not limited to the embodiments described above but is susceptible of various modification within the purport of the present invention.

In the embodiments described above, the input rotator is the male screw, and the linear motion member is the female screw meshing with the male screw, but this example is not limitative. For example, the input rotator may be a female screw, and the linear motion member may be a male screw meshing with the female screw. For example, the input rotator and the linear motion member can be configured in various manners in accordance with required specifications.

In the embodiments described above, the output rotator has a hollow structure, and the reaction force receiving member is provided on the end of the male screw that extends through the interior of the hollow structure, but this example is not limitative. For example, the reaction force receiving member may be provided on the end of the male screw that extends through the outside of the hollow structure. For example, the output rotator may have a solid structure. For example, the output rotator can be configured and the reaction force receiving member can be arranged in various manners in accordance with required specifications.

In the embodiments described above, the conversion mechanism is a ball screw mechanism, but this example is not limitative. For example, if the conversion mechanism is not a ball screw mechanism, it may include a belt pulley mechanism that transmits power with a belt stretched between pulleys. For example, the conversion mechanism can be configured in various manners in accordance with required specifications.

In the embodiments described above, the security power unit is provided separately from the regular electric motor as the electric motor, but this example is not limitative. For example, the brake device may not include the security power unit. For example, the brake device may brake the vehicle using only the regular electric motor as the electric motor. For example, the security power unit can be arranged in various manners in accordance with required specifications.

In the embodiments described above, the gear mechanism is a planetary gear mechanism including the sun gear, the planetary gears, and the internal gear, but this example is not limitative. For example, the gear mechanism may be an eccentric oscillation gear mechanism. For example, the brake device may not include the gear mechanism. For example, the gear mechanism can be configured and arranged in various manners in accordance with required specifications.

In the embodiments described above, the speed reducer includes an eccentric oscillation gear mechanism, but this example is not limitative. For example, the speed reducer may include a planetary gear mechanism. For example, the speed reducer may be a harmonic speed reducer. For example, the speed reducer can be configured in various manners in accordance with required specifications.

In the embodiments described above, the first rotation lock mechanism and the second rotation lock mechanism are controlled electrically, but this example is not limitative. For example, the brake device may include a mechanical lock mechanism such as a reverse input lock mechanism (e.g., torque diode). For example, the brake device may mechanically lock the rotation of a gear without control. For example, it is also possible that the brake device does not include at least one of the first and second rotation lock mechanisms. For example, the first and second rotation lock mechanisms can be configured for control and arranged in various manners in accordance with required specifications.

In the embodiments described above, the gear mechanism includes a first gear to which the output of the regular electric motor is input, a second gear to which the output of the security power unit is input, and a third gear for outputting to the speed reducer a rotational power input from the first gear or the second gear, the first gear is one of the sun gear and the planetary gears, the second gear is the other of the sun gear and the planetary gears, and the third gear is the internal gear, but this example is not limitative. For example, the first gear or the second gear may be the internal gear, and the third gear may be one of the sun gear and the planetary gears. For example, the gear mechanism and the speed reducer can be connected to each other in various manners in accordance with required specifications.

In the embodiments described above, the security power unit is an AC electric motor (an example of an electric motor), or the security power unit includes a spring and a retention mechanism, but these examples are not limitative. For example, the security power unit may be an air cylinder driven by compressed air or an air motor. The security power unit can be configured in various manners in accordance with required specifications.

The elements of the embodiments described above may be replaced with known elements within the purport of the present invention. Further, the modifications described above may be combined. In the embodiments disclosed herein, a member formed of multiple components may be integrated into a single component, or conversely, a member formed of a single component may be divided into multiple components. Irrespective of whether or not the components are integrated, they are acceptable as long as they are configured to attain the object of the invention.

What is claimed is:

1. A brake device for a railway vehicle, comprising:
an electric motor;
a speed reducer including an output rotator configured to output a rotational force input from the electric motor;
a conversion mechanism including an input rotator and a linear motion member, the input rotator being configured to receive the rotational force output from the output rotator, the linear motion member being configured to convert rotational motion of the input rotator into linear motion in moving directions parallel to a rotation axis of the input rotator; and
a friction member configured to receive the linear motion of the linear motion member to be pressed against a brake-applied member of a railway vehicle, so as to brake the railway vehicle,
wherein the input rotator is movable relative to the output rotator in the moving directions and is capable of transmitting rotational motion of the output rotator to the linear motion member.

2. The brake device for a railway vehicle according to claim 1, further comprising:
a housing that houses the conversion mechanism such that the linear motion member is movable in the moving directions; and
a reaction force receiving member provided between the housing and an end of the input rotator in one of the moving directions opposite to a direction for pressing the friction member against the brake-applied member, the reaction force receiving member being configured to receive a reaction force acting on the input rotator when the friction member is pressed against the brake-applied member.

3. The brake device for a railway vehicle according to claim 1,
wherein the input rotator is a male screw,
wherein the linear motion member is a female screw meshing with the male screw,
wherein the output rotator and the male screw have splines that engage with each other, such that the output rotator and the male screw are movable relative to each other in the moving directions, and
wherein the rotational motion of the output rotator input via the splines is transmitted to the male screw and converted into the linear motion of the female screw.

4. The brake device for a railway vehicle according to claim 1,
wherein the output rotator has a hollow structure, and
wherein a reaction force receiving member configured to receive a reaction force acting on the input rotator when the friction member is pressed against the brake-applied member is provided on an end of a male screw extending through an interior of the hollow structure.

5. The brake device for a railway vehicle according to claim 3, wherein the conversion mechanism is a ball screw mechanism.

6. The brake device for a railway vehicle according to claim 1, further comprising:
a security power unit provided separately from a regular electric motor as the electric motor; and
a gear mechanism configured to receive output of the regular electric motor and output of the security power unit,
wherein the gear mechanism includes:
a first gear configured to receive the output of the regular electric motor;
a second gear configured to receive the output of the security power unit; and
a third gear configured to output to the speed reducer a rotational power input from the first gear or the second gear.

7. The brake device for a railway vehicle according to claim 6,
wherein the gear mechanism is a planetary gear mechanism having a sun gear, planetary gears, and an internal gear,
wherein the first gear is one of the sun gear and the planetary gears,
wherein the second gear is the other of the sun gear and the planetary gears, and
wherein the third gear is the internal gear.

8. The brake device for a railway vehicle according to claim 7,
wherein the security power unit includes a spring and a retention mechanism configured to retain the spring in a biased state,
wherein the first gear is the sun gear,
wherein the second gear is the planetary gears, and
wherein a reduction ratio between the sun gear and the internal gear is greater than a reduction ratio between the planetary gears and the internal gear.

9. The brake device for a railway vehicle according to claim 8,
wherein a first rotation lock mechanism capable of locking rotation of the first gear is provided between the regular electric motor and the first gear,
wherein the retention mechanism is a second rotation lock mechanism capable of locking rotation of the second gear,
wherein the brake device further comprises a control unit configured to control the first rotation lock mechanism, the second rotation lock mechanism, and the regular electric motor, and
wherein the control unit puts the spring into the biased state by driving the regular electric motor while controlling the first rotation lock mechanism and the second rotation lock mechanism so as not to lock rotation of the first gear and the second gear.

10. The brake device for a railway vehicle according to claim 6,
wherein a first rotation lock mechanism capable of locking rotation of the first gear is provided between the regular electric motor and the first gear,
wherein a second rotation lock mechanism capable of locking rotation of the second gear is provided between the security power unit and the second gear,
wherein when the regular electric motor is driven, the first rotation lock mechanism does not lock rotation of the first gear, and the second rotation lock mechanism locks rotation of the second gear, and
wherein when the security power unit is driven, the first rotation lock mechanism locks rotation of the first gear, and the second rotation lock mechanism does not lock rotation of the second gear.

11. The brake device for a railway vehicle according to claim 7,
wherein the security power unit is a direct current (DC) electric motor,
wherein the regular electric motor is an alternating current (AC) electric motor,
wherein the first gear is the planetary gears,
wherein the second gear is the sun gear, and
wherein a reduction ratio between the sun gear and the internal gear is greater than a reduction ratio between the planetary gears and the internal gear.

12. The brake device for a railway vehicle according to claim 1,
wherein the speed reducer includes:
a case rotatably retaining an input gear, the input gear being configured to receive output of the electric motor;
a crankshaft rotatably supported by the case and having an eccentric region that revolves as the crankshaft receives rotation of the input gear;
an oscillating gear having external teeth, a number of the external teeth being smaller than a number of internal tooth pins, the external teeth being meshed with the internal tooth pins, the oscillating gear being configured to receive a revolving force from the eccentric region of the crankshaft to rotate oscillatorily;
the output rotator having an annular shape and rotatably supported by the case, the output rotator having a plurality of pin grooves, the plurality of pin grooves being formed in an inner periphery of the output rotator and spaced equally in a circumferential direction; and
a plurality of internal tooth pins rotatably retained in the plurality of pin grooves of the output rotator.
